(19) United States
(12) Patent Application Publication
(10) Pub. No.: US 2026/0349298 A1
(43) Pub. Date: Nov. 5, 2026

(54) DISPLAY PANEL AND DISPLAY DEVICE

(71) Applicant: SHANGHAI TIANMA MICROELECTRONICS CO., LTD., Shanghai (CN)

(72) Inventors: Yongli QIAN, Shanghai (CN); Jian ZHAO, Shanghai (CN)

(73) Assignee: SHANGHAI TIANMA MICROELECTRONICS CO., LTD., Shanghai (CN)

(21) Appl. No.: 19/728,358

(22) Filed: Jul. 2, 2026

(30) Foreign Application Priority Data
Dec. 19, 2025 (CN) 202511938966.4

(51) Int. Cl. G02F 1/1333

(52) U.S. Cl. CPC G02F 1/133382

(57) ABSTRACT

A display panel and a display device are provided. The display panel includes multiple heating lines, where at least a part of the heating line is located in the display area, and two ends of the heating line are located in a non-display area. The heating line includes at least two first sub-segments that extend along a first direction and are arranged along a second direction. The number of first sub-segments in the second heating line is different from that of first sub-segments in the first heating line, and/or, an arrangement density of the first sub-segments along the second direction in the second heating line is different from that of the first sub-segments along the second direction in the first heating line, and a difference between a length of the first heating line and a length of the second heating line is not greater than a first threshold.

This application claims benefit of priority to Chinese patent application No. 202511938966.4, titled “DISPLAY PANEL AND DISPLAY DEVICE”, filed Dec. 19, 2025, with the China National Intellectual Property Administration, the entire of which is incorporated herein by reference.

### FIELD

The present application relates to the field of display, and more particularly, to a display panel and a display device.

### BACKGROUND

For liquid crystal display panels that may be used in low-temperature scenarios, such as on-board liquid crystal display panels, an increase in the viscosity of liquid crystal molecules at low temperatures leads to an increased response time. This can easily cause issues such as image quality degradation and dynamic image trailing in the display panel, and in severe cases, may even prevent the display panel from displaying normally.

In view of this, related art has proposed providing heating lines in the display panel to heat the liquid crystal molecules, thereby achieving the purpose of normal display in low-temperature environments. However, with the diversification of display panel shape designs, there are more and more irregularly-shaped display panels. Limited by the wiring space in the irregularly-shaped display area, the resistance values of heating lines located at different positions in the display area vary greatly, resulting in different heating powers for heating lines with different resistance values and uneven heating temperature distribution, which affects the display effect of the display panel under low-temperature conditions.

### SUMMARY

In view of this, the present disclosure provides a display panel and a display device to address the issue of uneven heating temperature distribution in the irregularly-shaped display area of a display panel affecting the display effect of the display panel under low-temperature conditions.

The present disclosure provides a display panel, including:
a display area and a non-display area at least partially surrounding the display area, where the display area is non-rectangular, and
multiple heating lines, where at least a part of the heating line is located in the display area, and two ends of the heating line are located in the non-display area,
where the heating line includes at least two first sub-segments, the first sub-segments extend along a first direction and are arranged along a second direction, and the first direction and the second direction intersect each other; the first sub-segments in a same one of the heating lines are connected in series through a second sub-segment,
where the multiple heating lines include a first heating line and a second heating line, where the number of first sub-segments in the second heating line is different from the number of first sub-segments in the first heating line, and/or, an arrangement density of the first sub-segments along the second direction in the second heating line is different from an arrangement density of the first sub-segments along the second direction in the first heating line,
where a difference between a length of the first heating line and a length of the second heating line is not greater than a first threshold.

Based on the same inventive concept, the present disclosure further provides a display device, including the display panel of the present disclosure.

### BRIEF DESCRIPTION OF THE DRAWINGS

To more clearly illustrate the embodiments of the present disclosure, the drawings required for describing the embodiments or the prior art are briefly introduced below. In one embodiment, the drawings in the following description are only some embodiments of the present disclosure.

FIG. 1 is a schematic structural diagram of a display panel according to the present disclosure;

FIG. 2 is a schematic temperature distribution diagram of the display panel shown in FIG. 1;

FIG. 3 is a schematic structural diagram of another display panel according to the present disclosure;

FIG. 4 is a schematic structural diagram of another display panel according to the present disclosure;

FIG. 5 is a schematic structural diagram of another display panel according to the present disclosure;

FIG. 6 is a schematic structural diagram of another display panel according to the present disclosure;

FIG. 7 is a schematic structural diagram of another display panel according to the present disclosure;

FIG. 8 is a schematic structural diagram of another display panel according to the present disclosure;

FIG. 9 is a schematic structural diagram of another display panel according to the present disclosure;

FIG. 10 is a schematic structural diagram of another display panel according to the present disclosure;

FIG. 11 is a schematic structural diagram of another display panel according to the present disclosure;

FIG. 12 is a schematic partial structural diagram of a display panel according to the present disclosure;

FIG. 13 is a schematic partial structural diagram of another display panel according to the present disclosure;

FIG. 14 is a schematic partial structural diagram of another display panel according to the present disclosure;

FIG. 15 is a schematic partial structural diagram of another display panel according to the present disclosure;

FIG. 16 is a schematic partial structural diagram of another display panel according to the present disclosure;

FIG. 17 is a schematic partial structural diagram of another display panel according to the present disclosure;

FIG. 18 is a schematic partial structural diagram of another display panel according to the present disclosure;

FIG. 19 is a schematic partial structural diagram of another display panel according to the present disclosure;

FIG. 20 is a schematic partial structural diagram of another display panel according to the present disclosure;

FIG. 21 is a schematic partial structural diagram of another display panel according to the present disclosure;

FIG. 22 is a schematic partial structural diagram of another display panel according to the present disclosure;

FIG. 23 is a schematic partial structural diagram of another display panel according to the present disclosure;

FIG. 24 is a schematic partial structural diagram of another display panel according to the present disclosure;

FIG. 25 is a schematic partial structural diagram of another display panel according to the present disclosure;

FIG. 26 is a schematic structural diagram of another display panel according to the present disclosure;

FIG. 27 is a schematic structural diagram of a display device according to the present disclosure.

### DESCRIPTION OF REFERENCE NUMERALS

100: Display panel; AA: Display area; NA: Non-display area; AA1: Regular area; AA2: Irregularly-shaped area; A1: First display sub-area; A2: Second display sub-area; 10: Heating line; 11: First sub-segment; 12: Second sub-segment; 101: First heating line; 102: Second heating line; 20: Positive heating bus; 30: Negative heating bus; B1: First edge; B2: Second edge; B3: Third edge; B4: Fourth edge; X: First direction; Y: Second direction; B11: First sub-edge; B12: Second sub-edge; L1: First virtual line; A21: First-type second display sub-area; L2: Second virtual line; B21: Third sub-edge; B22: Fourth sub-edge; A22: Second-type second display sub-area; 21: First part; 22: Second part; 31: Third part; 32: Fourth part; 101-1: First-type first heating line; 101-2: Second-type first heating line; Pixel: Sub-pixel; Scan: Gate line; Data: Data line; H: Row direction; V: Column direction; M1: First metal layer; M2: Second metal layer; M3: Third metal layer; M4: Fourth metal layer; R: Red sub-pixel; G: Green sub-pixel; B: Blue sub-pixel; PG: Pixel group; TP: Touch control line; NA1: First area; NA2: Second area; NA3: Third area; S1: Data fan-out line; S2: Touch control fan-out line; IC: Drive integrated circuit; S11: First data fan-out line; S12: Second data fan-out line; S3: Data connection line; S4: Touch control connection line; 200: Display device.

### DETAILED DESCRIPTION OF THE EMBODIMENTS

The embodiments of the present disclosure will be clearly and completely described below in conjunction with the drawings in the embodiments of the present disclosure. In one embodiment, the described embodiments are only part of the embodiments of the present disclosure, rather than all of the embodiments.

The terms “first”, “second” and the like in the description and claims of the present disclosure and the above drawings are used to distinguish similar objects, and are not necessarily used to describe a specific order or sequence. The terms used in this way can be interchanged under appropriate circumstances, and this is a way of distinguishing objects of the same attribute in the description of the embodiments of the present disclosure. Furthermore, the terms “include” and “have” and any variations thereof are intended to cover non-exclusive inclusion, and a process, method, system, product or device including a series of units is not necessarily limited to those units, but may include other units not explicitly listed or inherent to these processes, methods, products or devices.

As mentioned in the background section, with the diversification of display panel shape designs, there are more and more irregularly-shaped display panels. Limited by the wiring space in the irregularly-shaped display area, the resistance values of heating lines located at different positions in the display area vary greatly, resulting in different heating powers for heating lines with different resistance values and uneven heating temperature distribution, which affects the display effect of the display panel under low-temperature conditions.

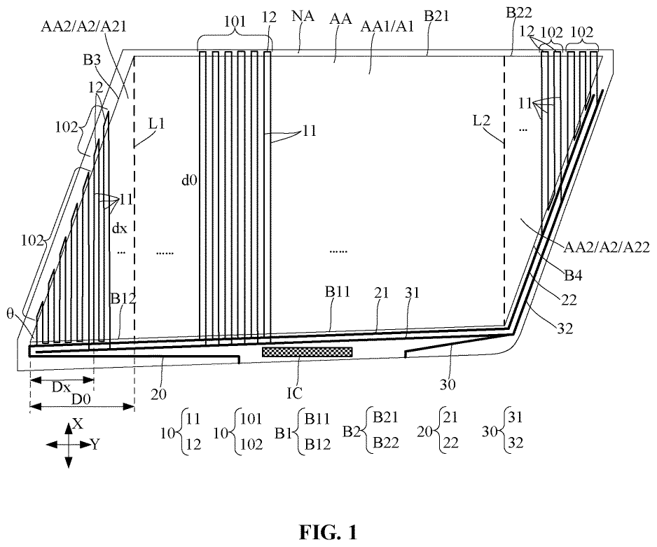

In view of this, the present disclosure provides a display panel. FIG. 1 shows a schematic structural diagram of a display panel according to the present disclosure. As shown in FIG. 1, the display panel includes a display area AA and a non-display area NA at least partially surrounding the display area AA. The display area AA is non-rectangular, i.e., the display area AA is an irregularly-shaped display area.

As shown in FIG. 1, the display panel further includes multiple heating lines 10. At least a part of the heating line 10 is located in the display area AA, and two ends of the heating line 10 are located in the non-display area NA. Each of the heating lines 10 includes at least two first sub-segments 11, the first sub-segments 11 extend along a first direction X and are arranged/distributed along a second direction Y, and the first direction X and the second direction Y intersect. The first sub-segments 11 in one heating line 10 are connected in series through a second sub-segment 12. That is to say, one heating line 10 includes z first sub-segments 11, where z≥2, and z is an integer. These z first sub-segments 11 extend along the first direction X and are arranged along the second direction Y. Two adjacent first sub-segments 11 are connected by a second sub-segment 12, and these z first sub-segments 11 are connected in series.

As shown in FIG. 1, the display panel may further include a positive heating bus 20 and a negative heating bus 30 located in the non-display area NA. One end of the heating line 10 is electrically connected to the positive heating bus 20, and another end of the heating line 10 is electrically connected to the negative heating bus 30. The positive heating bus 20 and the negative heating bus 30 are then electrically connected to a heating flexible circuit board (not shown in the figure) to apply a voltage to both ends of the heating line 10.

It can also be understood that the heating line 10 includes at least two first sub-segments 11 extending along the first direction X and arranged along the second direction Y, i.e., the part of the heating line 10, in the display area AA, is arranged in a winding manner, and the heating line 10 can heat the liquid crystal molecules in the display area AA more uniformly.

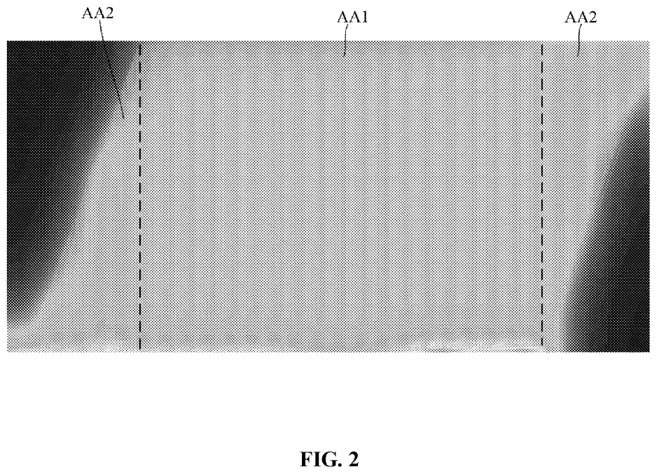

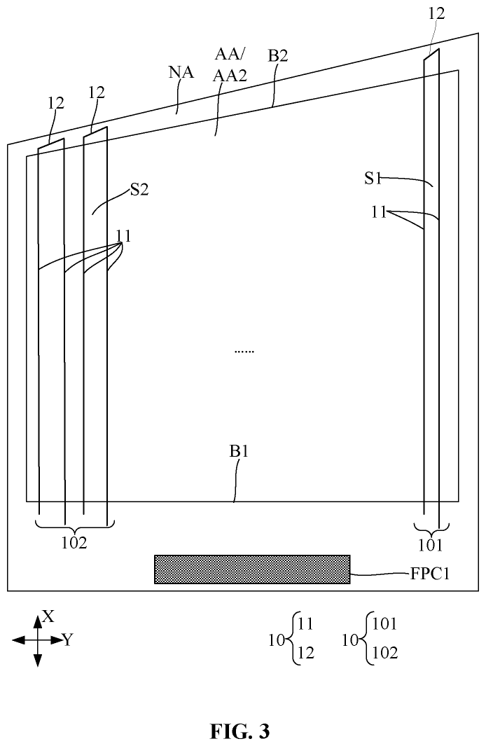

In view of the issues mentioned in the background section, in the display panel according to the present disclosure, in one embodiment, as shown in FIG. 1, the multiple heating lines 10 include a first heating line 101 and a second heating line 102. One of the first heating line 101 and the second heating line 102 may be located in the regular area AA1, and the other may be located in the irregularly-shaped area AA2. By setting the number of the first sub-segments 11 in the second heating line 102 to be different from the number of the first sub-segments 11 in the first heating line 101, the difference between the length of the first heating line 101 and the length of the second heating line 102 is made not greater than (i.e., less than or equal to) a first threshold. That is, the length of the first heating line 101 and the length of the second heating line 102 are approximately equal to each other, and the resistances of these two heating lines are approximately equal to each other, and thus the heating powers of these two heating lines are approximately equal to each other, thereby improving the uniformity of heating temperatures in different regions of the irregularly-shaped display area (such as the rectangular regular area AA1 and the non-rectangular irregularly-shaped area AA2). Accordingly, FIG. 2 shows a schematic temperature distribution diagram of the display panel shown in FIG. 1. Compared with FIG. 3, it can be seen that the temperature distribution in the irregularly-shaped area AA2 and the regular area AA1 is significantly more uniform.

In one embodiment, as shown in FIG. 3, which shows a schematic structural diagram of another display panel according to the present disclosure, the multiple heating lines 10 include a first heating line 101 and a second heating line 102, and both the first heating line 101 and the second heating line 102 are located in the irregularly-shaped area AA2 (or the entire display area AA is an irregularly-shaped area AA2). By setting the arrangement density of the first sub-segments 11 along the second direction Y in the second heating line 102 to be different from the arrangement density of the first sub-segments 11 along the second direction Y in the first heating line 101, the difference between the length of the first heating line 101 and the length of the second heating line 102 is made not greater than (i.e., less than or equal to) a first threshold. That is, the length of the first heating line 101 and the length of the second heating line 102 are approximately equal to each other, and the resistances of these two heating lines are approximately equal to each other, and thus the heating powers of these two heating lines are approximately equal to each other, thereby improving the uniformity of heating temperatures in different regions of the irregularly-shaped display area. In addition, as shown in FIG. 3, the multiple heating lines 10 may also be directly electrically connected to a heating flexible circuit board FPC1, to apply a voltage to both ends of the heating line 10.

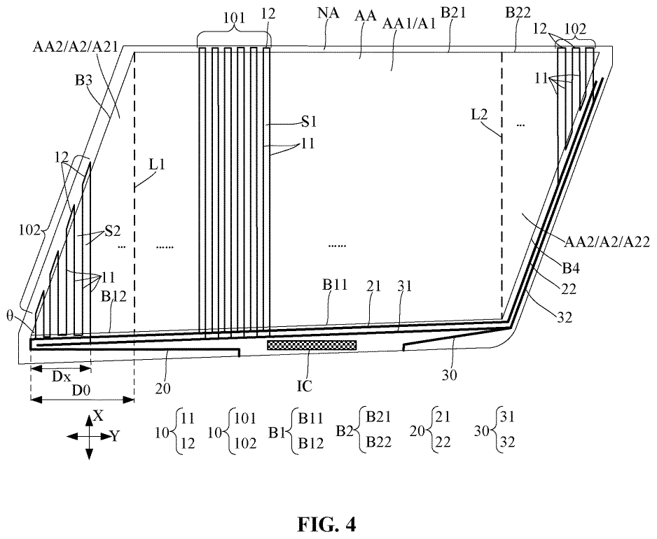

In one embodiment, as shown in FIG. 4, which shows a schematic structural diagram of another display panel according to the present disclosure, the multiple heating lines 10 include a first heating line 101 and a second heating line 102. One of the first heating line 101 and the second heating line 102 may be located in the regular area AA1, and the other may be located in the irregularly-shaped area AA2. It is set both the number of the first sub-segments 11 in the second heating line 102 to be different from the number of the first sub-segments 11 in the first heating line 101, and the arrangement density of the first sub-segments 11 along the second direction Y in the second heating line 102 to be different from the arrangement density of the first sub-segments 11 along the second direction Y in the first heating line 101. This makes the difference between the length of the first heating line 101 and the length of the second heating line 102 not greater than (i.e., less than or equal to) a first threshold. That is, the length of the first heating line 101 and the length of the second heating line 102 are approximately equal to each other, and the resistances of these two heating lines are approximately equal to each other, and thus the heating powers of these two heating lines are approximately equal to each other, thereby improving the uniformity of heating temperatures in different regions of the irregularly-shaped display area.

The arrangement density of the first sub-segments 11 along the second direction Y in the heating line 10 is closely related to the spacing between two adjacent first sub-segments 11 in the heating line 10. The larger the spacing between two adjacent first sub-segments 11 in the heating line 10, the smaller the arrangement density of the first sub-segments 11 along the second direction Y in the heating line 10, and the sparser the arrangement of the first sub-segments 11 along the second direction Y in the heating line 10. Conversely, the smaller the spacing between two adjacent first sub-segments 11 in the heating line 10, the larger the arrangement density of the first sub-segments 11 along the second direction Y in the heating line 10, and the denser the arrangement of the first sub-segments 11 along the second direction Y in the heating line 10.

From the above, in the display panel according to the present disclosure, for the irregularly-shaped display area, by setting the number of the first sub-segments 11 in the second heating line 102 to be different from the number of the first sub-segments 11 in the first heating line 101, and/or, the arrangement density of the first sub-segments 11 along the second direction Y in the second heating line 102 to be different from the arrangement density of the first sub-segments 11 along the second direction Y in the first heating line 101, the difference between the lengths of the two heating lines is made not greater than (i.e., less than or equal to) a first threshold. That is, the lengths of the two heating lines are approximately equal to each other, and the resistances of the two heating lines are approximately equal to each other, and thus the heating powers of the two heating lines are approximately equal to each other, thereby improving the heating uniformity in different regions of the irregularly-shaped display area, and improving the display effect of the display panel under low-temperature conditions.

The display panel includes multiple sub-pixels arranged in an array along a row direction and a column direction. In one embodiment, the first threshold may be not greater than the length of 10 sub-pixels, i.e., the difference between the length of the first heating line 101 and the length of the second heating line 102 in the display panel is less than or equal to the length of 10 sub-pixels, and the heating power of the first heating line 101 and the heating power of the second heating line 102 are approximately equal to each other.

On the basis that the length of the first heating line 101 and the length of the second heating line 102 in the display panel are approximately equal to each other, thereby making the heating power of the first heating line 101 and the heating power of the second heating line 102 approximately equal to each other, further, as shown in FIG. 3 and FIG. 4, it can be set that a difference between an area S1 of the display area corresponding to the region enclosed by the first heating line 101 and an area S2 of the display area corresponding to the region enclosed by the second heating line 102 is not greater than (i.e., less than or equal to) a second threshold. That is, the area S1 of the display area corresponding to the region enclosed by the first heating line 101 and the area S2 of the display area corresponding to the region enclosed by the second heating line 102 are approximately equal to each other. In this way, the heating power per unit area (i.e., heat generation per unit area) of the display area corresponding to the first heating line 101 is approximately equal to that of the display area corresponding to the second heating line 102, thereby further improving the heating uniformity in different regions of the irregularly-shaped display area.

The area of the display area corresponding to the region enclosed by the heating line 10 is the area of the display area corresponding to the entire region enclosed by each two adjacent first sub-segments 11 in the heating line 10, and is also the area of multiple sub-pixels corresponding to the region enclosed by the heating line 10.

In one embodiment, the second threshold may be not greater than 10% of the area S1 of the display area corresponding to the region enclosed by the first heating line 101, or the second threshold may be not greater than 10% of the area S2 of the display area corresponding to the region enclosed by the second heating line 102, and the heating amount per unit area of a corresponding region of the display area by the first heating line 101 is substantially equal to the heating amount per unit area of a corresponding region of the display area by the second heating line 102.

The following describes in detail by way of specific embodiments how the first heating line 101 and the second heating line 102 are designed for different irregularly-shaped display areas.

In some embodiments of the present disclosure, as shown in FIG. 3, in the display panel, the display area AA includes a first edge B1 and a second edge B2 arranged opposite to each other along the first direction X, and the first edge B1 and the second edge B2 are non-parallel with each other. Both ends of the first heating line 101 and both ends of the second heating line 102 are located on a side of the first edge B1 of the display area AA. Both ends of the first sub-segment 11 of the first heating line 101 respectively extend toward the first edge B1 and the second edge B2 of the display area AA and both ends of the first sub-segment 11 of the second heating line 102 respectively extend toward the first edge B1 and the second edge B2 of the display area AA. Thus, both the first heating line 101 and the second heating line 102 start from the side of the first edge B1 of the display area AA, wind at least one turn between the first edge B1 and the second edge B2 of the display area AA, and finally return to the side of the first edge B1 of the display area AA, to heat the corresponding region of the display area.

Since the first edge B1 and the second edge B2 of the display area AA are non-parallel with each other, i.e., the display area AA is an irregularly-shaped display area, and both the first heating line 101 and the second heating line 102 wind between the non-parallel first edge B1 and second edge B2 of the display area AA, when the number of the first sub-segments 11 in the second heating line 102 is equal to the number of the first sub-segments 11 in the first heating line 101, the average length of the first sub-segments 11 in the second heating line 102 is inconsistent with the average length of the first sub-segments 11 in the first heating line 101. In one embodiment, the average length of the first sub-segments 11 in the second heating line 102 is smaller than the average length of the first sub-segments 11 in the first heating line 101. In this case, in order to make the difference between the length of the first heating line 101 and the length of the second heating line 102 not greater than the first threshold, the arrangement density of the first sub-segments 11 along the second direction Y in the second heating line 102 can be set to be smaller than the arrangement density of the first sub-segments 11 along the second direction Y in the first heating line 101. Thus, by appropriately increasing the spacing between two adjacent first sub-segments 11 in the second heating line 102, i.e., appropriately increasing the length of the second sub-segment 12 connecting the two adjacent first sub-segments 11 in the second heating line 102, the length of the first heating line 101 and the length of the second heating line 102 are made approximately equal to each other, and the heating power of the first heating line 101 and the heating power of the second heating line 102 are approximately equal to each other. It can also make the area of the display area corresponding to the region enclosed by the first heating line 101 and the area of the display area corresponding to the region enclosed by the second heating line 102 approximately equal to each other, thereby improving the heating uniformity of the display panel as a whole.

In one embodiment, as shown in FIG. 3, both the first heating line 101 and the second heating line 102 include two first sub-segments 11. Then, the fact that the arrangement density of the first sub-segments 11 along the second direction Y in the second heating line 102 is smaller than the arrangement density of the first sub-segments 11 along the second direction Y in the first heating line 101 is, in one embodiment, manifested as: the spacing between the two first sub-segments 11 in the second heating line 102 is larger than the spacing between the two first sub-segments 11 in the first heating line 101, and the length of the first heating line 101 and the length of the second heating line 102 are approximately equal to each other. Thus, the heating power of the first heating line 101 and the heating power of the second heating line 102 are approximately equal to each other, and the area of the display area corresponding to the region enclosed by the first heating line 101 and the area of the display area corresponding to the region enclosed by the second heating line 102 are approximately equal to each other, thereby improving the heating uniformity of the display panel as a whole.

In the case of the display panel shown in FIG. 3, the first edge B1 and the second edge B2 of the display area AA are non-parallel with each other, and the first heating line 101 and the second heating line 102 can be any two heating lines with unequal average lengths of the first sub-segments 11, but are not limited to the first heating line 101 and the second heating line 102 shown in FIG. 3.

In some embodiments of the present disclosure, as shown in FIG. 1, in the display panel, the display area AA includes a first display sub-area A1 and a second display sub-area A2. In one embodiment, the first display sub-area A1 is a rectangular regular area AA1, and the second display sub-area A2 is a non-rectangular irregularly-shaped area AA2. It can be seen that if the heating line 10 at least partially located in the second display sub-area A2 and the heating line 10 at least partially located in the first display sub-area A1 adopt the same layout design, the lengths of the heating line at least partially located in the second display sub-area A2 and the heating line at least partially located in the first display sub-area A1 differ with each other significantly. In view of the above, the heating line 10 at least partially located in the first display sub-area A1 can be set as the first heating lines 101, the first heating line 101 including m first sub-segments 11, and the heating line 10 at least partially located in the second display sub-area A2 can be set as the second heating line 102, the second heating line 102 including n first sub-segments 11, where n>m, m≥2, n≥4, and m and n are both even numbers. With such a configuration, the number n of the first sub-segments 11 in the second heating line 102 at least partially located in the second display sub-area A2 (i.e., the irregularly-shaped area AA2) is different from the number m of the first sub-segments 11 in the first heating line 101 at least partially located in the first display sub-area A1 (i.e., the regular area AA1), and the length of the second heating line 102 at least partially located in the second display sub-area A2 (i.e., the irregularly-shaped area AA2) is approximately equal to the length of the first heating line 101 at least partially located in the first display sub-area A1 (i.e., the regular area AA1). Thus, the heating power of the second heating line 102 at least partially located in the second display sub-area A2 (i.e., the irregularly-shaped area AA2) is approximately equal to the heating power of the first heating line 101 at least partially located in the first display sub-area A1 (i.e., the regular area AA1). It can also make the area of the display area corresponding to the region enclosed by the first heating line 101 and the area of the display area corresponding to the region enclosed by the second heating line 102 approximately equal to each other, thereby improving the heating uniformity of the display panel as a whole.

Furthermore, both the first heating line 101 and the second heating line 102 include an even number of first sub-segments 11. That is to say, both ends of the first heating line 101 are located on the same side of the display area AA, and both ends of the second heating line 102 are also located on the same side of the display area AA. This can facilitate the arrangement of the positive heating bus 20, the negative heating bus 30, and the heating flexible circuit board.

In one embodiment, as shown in FIG. 1, the first heating line 101 at least partially located in the first display sub-area A1 (i.e., the regular area AA1) may include two first sub-segments 11, i.e., m=2, and the length of each first sub-segment 11 is d0, so the length of the first heating line 101 is approximately 2d0. The second heating line 102 at least partially located in the second display sub-area A2 (i.e., the irregularly-shaped area AA2) includes n first sub-segments 11, where n is an even number greater than 2, i.e., the second heating line 102 adopts a zigzag design with n segments of first sub-segments 11. The lengths of these n first sub-segments 11 are d1, d2 . . . dx . . . dn respectively, so the length of the second heating line 102 is approximately d1+d2+ . . . dx . . . +dn. By adjusting the number n of the first sub-segments 11 in the second heating line 102, the sum of the lengths d1, d2 . . . dx . . . dn of the n first sub-segments 11 in the second heating line 102 can be made approximately equal to the sum of the lengths d0 of the m (e.g., 2) first sub-segments 11 in the first heating line 101, i.e., d1+d2+ . . . dx . . . +dn=2d0. This makes the length of the second heating line 102 approximately equal to the length of the first heating line 101, and the heating power of the second heating line 102 is approximately equal to the heating power of the first heating line 101. It can also make the area of the display area corresponding to the region enclosed by the first heating line 101 and the area of the display area corresponding to the region enclosed by the second heating line 102 approximately equal, thereby improving the heating uniformity of the display panel as a whole.

Here, the lengths of the first heating line 101 and the second heating line 102 are made approximately equal to each other mainly by adjusting the number of the first sub-segments 11 in the first heating line 101 and the second heating line 102. In the calculation, the sum of the lengths of all first sub-segments 11 in the first heating line 101 is equivalent to the length of the first heating line 101, and the sum of the lengths of all first sub-segments 11 in the second heating line 102 is equivalent to the length of the second heating line 102, omitting the lengths of the second sub-segments 12 in the first heating line 101 and the second heating line 102. In practical applications, the total length of all second sub-segments 12 in the first heating line 101 and/or the total length of all second sub-segments 12 in the second heating line 102 can also be adjusted to make the length of the second heating line 102 and the length of the first heating line 101 closer to each other.

In practical applications, even if the numbers of the first sub-segments 11 in the first heating line 101 and the second heating line 102 are adjusted, the length of the second heating line 102 and the length of the first heating line 101 generally cannot be completely equal to each other. Therefore, further in one embodiment, as shown in FIG. 4, the arrangement density of the first sub-segments 11 along the second direction Y in the second heating line 102 can be further set to be different from the arrangement density of the first sub-segments 11 along the second direction Y in the first heating line 101, to make the lengths of the second heating line 102 and the first heating line 101 even closer to each other and the areas of the display areas corresponding to the enclosed regions even closer to each other, and the heating power per unit area corresponding to the second heating line 102 and the first heating line 101 is even closer to each other, further improving the heating uniformity of the display panel.

In practice, in addition to adjusting the numbers of the first sub-segments 11 in the first heating line 101 and the second heating line 102 to make the lengths of the second heating line 102 and the first heating line 101 approximately equal to each other and the areas of the display areas corresponding to the enclosed regions approximately equal to each other, the arrangement density of the first sub-segments 11 along the second direction Y in the second heating line 102 can be further set to be equal to the arrangement density of the first sub-segments 11 along the second direction Y in the first heating line 101, as shown in FIG. 1, to achieve the effect of uniform heating of the display panel.

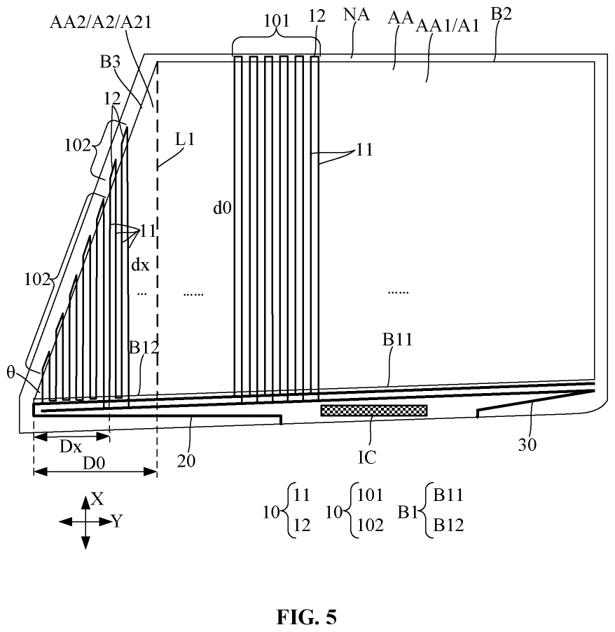

Further, in some embodiments of the present disclosure, as shown in FIG. 1, FIG. 4, and FIG. 5 to FIG. 8, FIG. 5 to FIG. 8 respectively show schematic structural diagrams of four more display panels according to the present disclosure. It can be seen that the display area AA includes a first edge B1 and a second edge B2 arranged opposite to each other along the first direction X, and a third edge B3 connecting the first edge B1 and the second edge B2. An included angle between the third edge B3 and the first edge B1 is an acute angle, and an included angle between the third edge B3 and the second edge B2 is an obtuse angle. The first edge B1 is divided into a first sub-edge B11 and a second sub-edge B12 by a first virtual line L1, and the first virtual line L1 extends along the first direction X. The first display sub-area A1 (e.g., the rectangular regular area AA1) includes the first sub-edge B11, the second edge B2, and the first virtual line L1. The second display sub-area A2 includes at least one first-type second display sub-area A21. The first-type second display sub-area A21 is an irregularly-shaped area, and the first-type second display sub-area A21 includes the second sub-edge B12, the third edge B3, and the first virtual line L1. Both ends of the first heating line 101 and both ends of the second heating line 102 in the first-type second display sub-area A21 are located on one side of the first edge B1 of the display area AA. Both ends of the first sub-segment 11 of the first heating line 101 respectively extend toward the first sub-edge B11 and the second edge B2. Both ends of the first sub-segment 11 of the second heating line 102 in the first-type second display sub-area A21 respectively extend toward the second sub-edge B12 and the third edge B3.

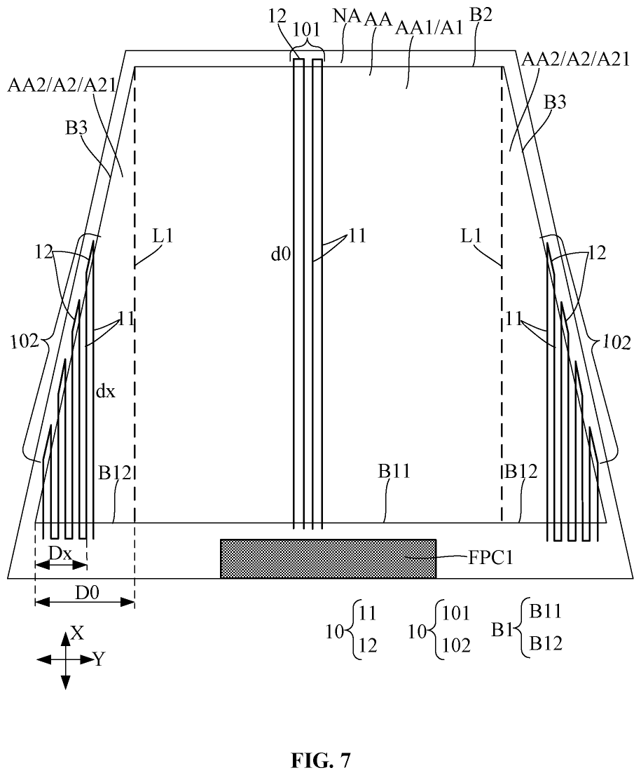

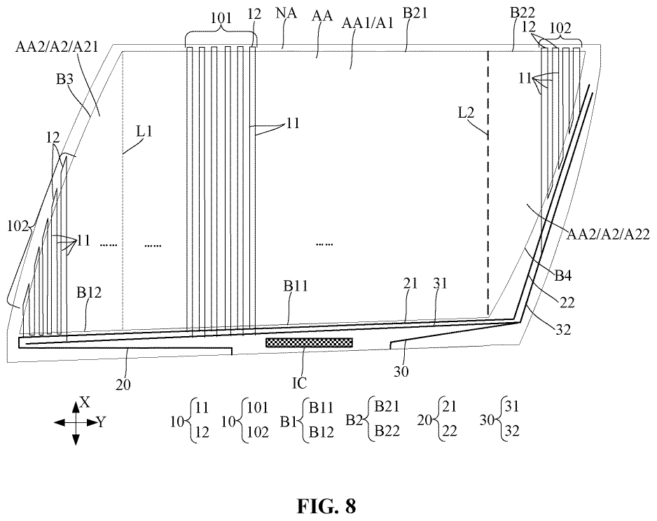

In one embodiment, there may be one first-type second display sub-area A21, located on one side of the first display sub-area A1 along the second direction Y, as shown in FIG. 1, FIG. 4 to FIG. 6, and FIG. 8. In one embodiment, there may be two first-type second display sub-areas A21, located on two opposite sides of the first display sub-area A1 along the second direction Y, as shown in FIG. 7.

In one embodiment, the first-type second display sub-area A21 may be triangular, as shown in FIG. 1, FIG. 4 to FIG. 7. In this case, the third edge B3 of the display area AA may be a straight edge forming an acute angle with the first edge B1 and an obtuse angle with the second edge B2. When the first-type second display sub-area A21 is a triangle, let the included angle between the third edge B3 and the first edge B1 of the display area AA be θ, and the length of the second sub-edge B12 in the first edge B1 be D0. Then, when the first virtual line L1 is perpendicular to the first edge B1, the length of the first sub-segment 11 in the first heating line 101 can be approximated as d0=D0×tanθ. Similarly, the length of the first sub-segment 11 in the second heating line 102 can be approximated as dx=Dx×tanθ, where Dx is the distance between the endpoint of the first edge B1 and the position of the first sub-segment 11 in the second heating line 102. Furthermore, the sum of the lengths d1, d2 . . . dx . . . dn of the n first sub-segments 11 in the second heating line 102 is approximately equal to the sum of the lengths d0 of the m (e.g., 2) first sub-segments 11 in the first heating line 101, i.e., d1+d2+ . . . dx . . . + dn=2d0, and the length of the second heating line 102 is approximately equal to the length of the first heating line 101. In other optional embodiments, the third edge B3 of the display area AA may also be a curved edge forming an acute angle with the first edge B1 and an obtuse angle with the second edge B2, as shown in FIG. 8.

When the display area AA includes a first edge B1 and a second edge B2 arranged opposite to each other along the first direction X, and a third edge B3 connecting the first edge B1 and the second edge B2, and the third edge B3 forms an acute angle with the first edge B1 and an obtuse angle with the second edge B2, the first edge B1 can be divided into a first sub-edge B11 and a second sub-edge B12 by the first virtual line L1, and the first sub-edge B11, the second edge B2, and the first virtual line L1 enclose the first display sub-area A1. The first display sub-area A1 may be rectangular. The second sub-edge B12, the third edge B3, and the first virtual line L1 enclose the first-type second display sub-area A21, and the first-type second display sub-area A21 is non-rectangular. That is, the display area AA includes the first display sub-area A1 and the first-type second display sub-area A21. By setting the numbers and/or arrangement densities of the first sub-segments 11 of the heating lines 10 in the first-type second display sub-area A21 and the first display sub-area A1 to be different from each other, the lengths of the heating lines 10 in the first-type second display sub-area A21 and the first display sub-area A1 are made approximately equal to each other and the areas of the display areas corresponding to the enclosed regions are also made approximately equal to each other, thereby improving the heating uniformity of the display panel.

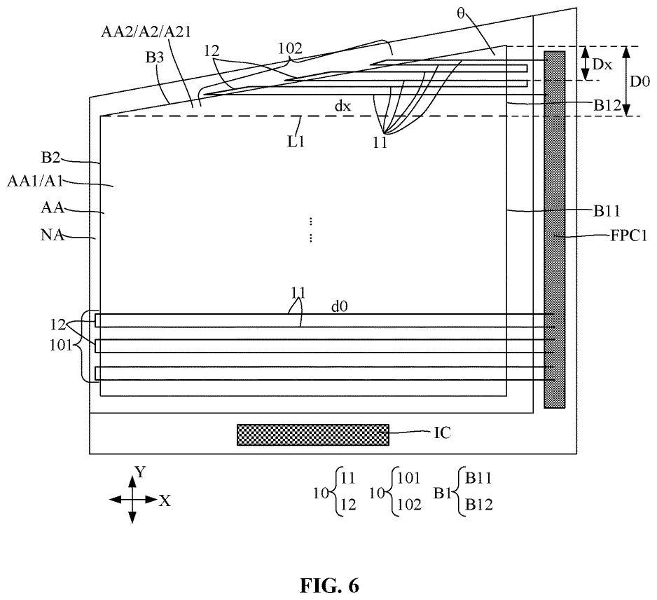

It can also be understood that when the display area AA includes the first display sub-area A1 and the first-type second display sub-area A21, considering that both ends of the first heating line 101 and both ends of the second heating line 102 in the first-type second display sub-area A21 can both be located on one side of the first edge B1 of the display area AA, therefore, referring to FIG. 1, FIG. 4, FIG. 5, and FIG. 8, the positive heating bus 20 and the negative heating bus 30 located in the non-display area NA of the display panel can be arranged on one side of the first edge B1 of the display area AA and extend along the first edge B1, to facilitate the electrical connection of one end of each heating line 10 to the positive heating bus 20 and another end of each heating line 10 to the negative heating bus 30. In addition, as shown in FIG. 6 and FIG. 7, the heating lines 10 in the display panel can, in one embodiment, be directly connected to the heating flexible circuit board FPC1.

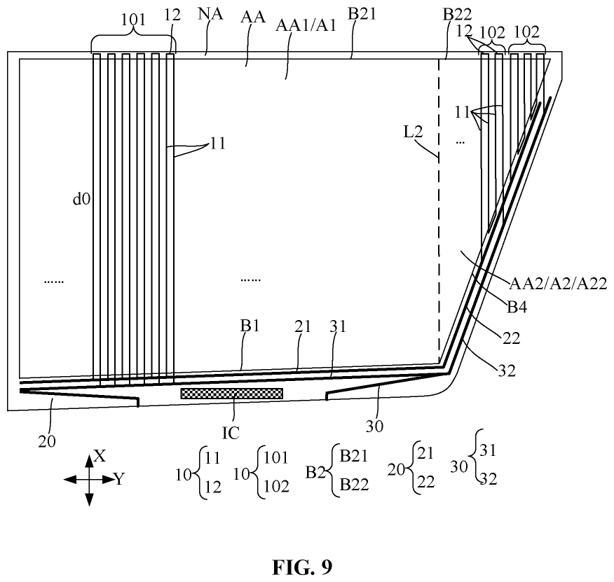

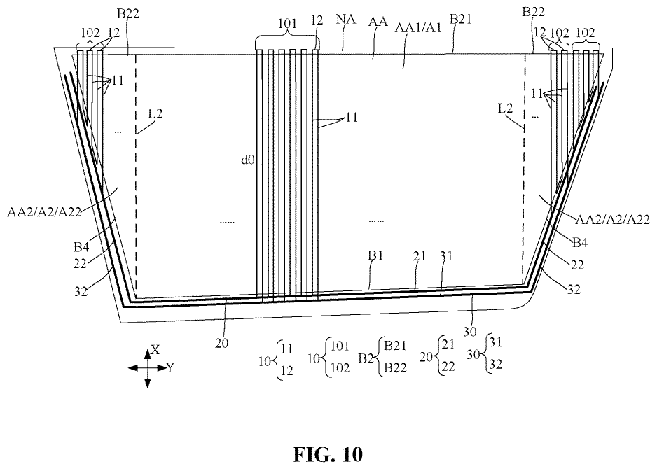

In some embodiments of the present disclosure, as shown in FIG. 1, FIG. 4, FIG. 8, FIG. 9, and FIG. 10, FIG. 9 and FIG. 10 show schematic structural diagrams of two more display panels according to the present disclosure. It can be seen that the display area AA includes a first edge B1 and a second edge B2 arranged opposite to each other along the first direction X, and a fourth edge B4 connecting the first edge B1 and the second edge B2. An included angle between the fourth edge B4 and the first edge B1 is an obtuse angle, and an included angle between the fourth edge B4 and the second edge B2 is an acute angle. The second edge B2 is divided into a third sub-edge B21 and a fourth sub-edge B22 by a second virtual line L2, and the second virtual line L2 extends along the first direction X. The first display sub-area A1 (e.g., the rectangular regular area AA1) includes the first edge B1, the third sub-edge B21, and the second virtual line L2. The second display sub-area A2 includes at least one second-type second display sub-area A22. The second-type second display sub-area A22 is an irregularly-shaped area, and the second-type second display sub-area A22 includes the fourth sub-edge B22, the fourth edge B4, and the second virtual line L2. Both ends of the first heating line 101 are located on one side of the first edge B1 of the display area AA, and both ends of the second heating line 102 in the second-type second display sub-area A22 are located on one side of the fourth edge B4 of the display area AA. Both ends of the first sub-segment 11 of the first heating line 101 respectively extend toward the first edge B1 and the third sub-edge B21. Both ends of the first sub-segment 11 of the second heating line 102 in the second-type second display sub-area A22 respectively extend toward the fourth edge B4 and the fourth sub-edge B22.

In one embodiment, there may be one second-type second display sub-area A22, located on one side of the first display sub-area A1 along the second direction Y, as shown in FIG. 1, FIG. 4, FIG. 8, and FIG. 9. In one embodiment, there may be two second-type second display sub-areas A22, located on two opposite sides of the first display sub-area A1 along the second direction Y, as shown in FIG. 10.

In one embodiment, the second-type second display sub-area A22 may be triangular, as shown in FIG. 1, FIG. 4, FIG. 9, and FIG. 10. In this case, the fourth edge B4 of the display area AA may be a straight edge forming an obtuse angle with the first edge B1 and an acute angle with the second edge B2. In other optional embodiments, the fourth edge B4 of the display area AA may also be a curved edge forming an obtuse angle with the first edge B1 and an acute angle with the second edge B2, as shown in FIG. 8.

When the display area AA includes a first edge B1 and a second edge B2 arranged opposite to each other along the first direction X, and a fourth edge B4 connecting the first edge B1 and the second edge B2, and the fourth edge B4 forms an obtuse angle with the first edge B1 and an acute angle with the second edge B2, the second edge B2 can be divided into a third sub-edge B21 and a fourth sub-edge B22 by the second virtual line L2, and the first edge B1, the third sub-edge B21, and the second virtual line L2 enclose the first display sub-area A1. The first display sub-area A1 may be rectangular. The fourth sub-edge B22, the fourth edge B4, and the second virtual line L2 enclose the second-type second display sub-area A22, and the second-type second display sub-area A22 is non-rectangular. That is, the display area AA includes the first display sub-area A1 and the second-type second display sub-area A22. By setting the numbers and/or arrangement densities of the first sub-segments of the heating lines 10 in the second-type second display sub-area A22 and the first display sub-area A1 to be different from each other, the lengths of the heating lines 10 in the second-type second display sub-area A22 and the first display sub-area A1 are made approximately equal to each other and the corresponding areas are also made approximately equal to each other, thereby improving the heating uniformity of the display panel.

It can also be understood that when the display area AA includes the first display sub-area A1 and the second-type second display sub-area A22, considering that both ends of the first heating line 101 can be located on one side of the first edge B1 of the display area AA, and both ends of the second heating line 102 in the second-type second display sub-area A22 can be located on one side of the fourth edge B4 of the display area AA, therefore, referring to FIG. 1, FIG. 4, and FIG. 8 to FIG. 10, the positive heating bus 20 located in the non-display area NA of the display panel can be set to include a first part 21 and a second part 22, and the negative heating bus 30 located in the non-display area NA of the display panel can be set to include a third part 31 and a fourth part 32. The first part 21 of the positive heating bus 20 and the third part 31 of the negative heating bus 30 are located on one side of the first edge B1 of the display area AA and extend along the first edge B1. The second part 22 of the positive heating bus 20 and the fourth part 32 of the negative heating bus 30 are located on one side of the fourth edge B4 of the display area AA and extend along the fourth edge B4, to facilitate the electrical connection of one end of each heating line 10 to the positive heating bus 20 and another end of each heating line 10 to the negative heating bus 30.

In some embodiments of the present disclosure, as shown in FIG. 1, FIG. 4, and FIG. 8, the display area AA includes a first edge B1 and a second edge B2 arranged opposite to each other along the first direction X, and a third edge B3 and a fourth edge B4 connecting the first edge B1 and the second edge B2. An included angle between the third edge B3 and the first edge B1 is an acute angle, and an included angle between the third edge B3 and the second edge B2 is an obtuse angle. An included angle between the fourth edge B4 and the first edge B1 is an obtuse angle, and an included angle between the fourth edge B4 and the second edge B2 is an acute angle. The first edge B1 is divided into a first sub-edge B11 and a second sub-edge B12 by a first virtual line L1, and the first virtual line L1 extends along the first direction X. The second edge B2 is divided into a third sub-edge B21 and a fourth sub-edge B22 by a second virtual line L2, and the second virtual line L2 extends along the first direction X. The first display sub-area A1 (e.g., the rectangular regular area AA1) includes the first sub-edge B11, the third sub-edge B21, the first virtual line L1, and the second virtual line L2. The second display sub-area A2 includes a first-type second display sub-area A21 and a second-type second display sub-area A22. The first-type second display sub-area A21 is an irregularly-shaped area, and the first-type second display sub-area A21 includes the second sub-edge B12, the third edge B3, and the first virtual line L1. The second-type second display sub-area A22 is an irregularly-shaped area, and the second-type second display sub-area A22 includes the fourth sub-edge B22, the fourth edge B4, and the second virtual line L2. Both ends of the first heating line 101 and both ends of the second heating line 102 in the first-type second display sub-area A21 are located on one side of the first edge B1 of the display area AA. Both ends of the second heating line 102 in the second-type second display sub-area A22 are located on one side of the fourth edge B4 of the display area AA. Both ends of the first sub-segment 11 of the first heating line 101 respectively extend toward the first sub-edge B11 and the third sub-edge B21. Both ends of the first sub-segment 11 of the second heating line 102 in the first-type second display sub-area A21 respectively extend toward the second sub-edge B12 and the third edge B3. Both ends of the first sub-segment 11 of the second heating line 102 in the second-type second display sub-area A22 respectively extend toward the fourth edge B4 and the fourth sub-edge B22.

In this case, the first-type second display sub-area A21 and the second-type second display sub-area A22 are located on two opposite sides of the first display sub-area A1 along the second direction Y, which is a combination of the above case where the display area AA includes the first display sub-area A1 and the first-type second display sub-area A21, and the case where the display area AA includes the first display sub-area A1 and the second-type second display sub-area A22.

In one embodiment, the first-type second display sub-area A21 may be triangular, and the second-type second display sub-area A22 may be triangular, as shown in FIG. 1 and FIG. 4. In this case, the third edge B3 of the display area AA may be a straight edge forming an acute angle with the first edge B1 and an obtuse angle with the second edge B2, and the fourth edge B4 of the display area AA may be a straight edge forming an obtuse angle with the first edge B1 and an acute angle with the second edge B2. In other optional embodiments, the third edge B3 of the display area AA may also be a curved edge forming an acute angle with the first edge B1 and an obtuse angle with the second edge B2, and the fourth edge B4 of the display area AA may also be a curved edge forming an obtuse angle with the first edge B1 and an acute angle with the second edge B2, as shown in FIG. 8.

When the display area AA includes the first display sub-area A1, the first-type second display sub-area A21, and the second-type second display sub-area A22, the first display sub-area A1 can be rectangular, and the first-type second display sub-area A21 and the second-type second display sub-area A22 are non-rectangular. The numbers and/or arrangement densities of the first sub-segments 11 of the heating lines 10 in the first-type second display sub-area A21 and the first display sub-area A1 can be set to be different from each other, and the lengths of the heating lines 10 in the first-type second display sub-area A21 and the first display sub-area A1 are approximately equal to each other and the areas of the display areas corresponding to the enclosed regions are approximately equal to each other. And the numbers and/or arrangement densities of the first sub-segments of the heating lines 10 in the second-type second display sub-area A22 and the first display sub-area A1 can be set to be different from each other, and the lengths of the heating lines 10 in the second-type second display sub-area A22 and the first display sub-area A1 are approximately equal to each other and the areas of the display areas corresponding to the enclosed regions are approximately equal to each other, thereby improving the heating uniformity of the display panel.

It can also be understood that when the display area AA includes the first display sub-area A1, the first-type second display sub-area A21, and the second-type second display sub-area A 22, considering that both ends of the first heating line 101 and both ends of the second heating line 102 in the first-type second display sub-area A 21 can both be located on one side of the first edge B1 of the display area AA, and both ends of the second heating line 102 in the second-type second display sub-area A22 can be located on one side of the fourth edge B4 of the display area AA, therefore, referring to FIG. 1, FIG. 4, and FIG. 8 to FIG. 10, the positive heating bus 20 located in the non-display area NA of the display panel can be set to include a first part 21 and a second part 22, and the negative heating bus 30 located in the non-display area NA of the display panel can be set to include a third part 31 and a fourth part 32. The first part 21 of the positive heating bus 20 and the third part 31 of the negative heating bus 30 are located on one side of the first edge B1 of the display area AA and extend along the first edge B1. The second part 22 of the positive heating bus 20 and the fourth part 32 of the negative heating bus 30 are located on one side of the fourth edge B4 of the display area AA and extend along the fourth edge B4, to facilitate the electrical connection of one end of each heating line 10 to the positive heating bus 20 and another end of each heating line 10 to the negative heating bus 30.

Regardless of whether the display area AA includes only the first display sub-area A1 and the first-type second display sub-area A21, or only the first display sub-area A1 and the second-type second display sub-area A22, or includes the first display sub-area A1, the first-type second display sub-area A21, and the second-type second display sub-area A22, in one embodiment, as shown in FIG. 1, and FIG. 4 to FIG. 10, along a direction towards the first display sub-area A1, the lengths of the first sub-segments 11 of the second heating line 102 in the second display sub-area A2 gradually increase. Accordingly, along a direction towards the first display sub-area A1, the numbers of the first sub-segments 11 of second heating lines 102 in the second display sub-area A2 gradually decrease.

Regardless of whether the display area AA includes only the first display sub-area A1 and the first-type second display sub-area A21, or only the first display sub-area A1 and the second-type second display sub-area A22, or includes the first display sub-area A1, the first-type second display sub-area A21, and the second-type second display sub-area A22, in one embodiment, as shown in FIG. 1, and FIG. 4 to FIG. 10, the first edge B1 and the second edge B2 of the display area AA may be arranged in parallel with each other. In this way, since both ends of the first sub-segment 11 of the first heating line 101 in the first display sub-area A1 respectively extend toward the first edge B1 and the second edge B2, the first sub-segments 11 in the first display sub-area A1 can be uniformly arranged along the second direction Y, simplifying the layout design of the first sub-segments 11 in the first display sub-area A1. In this case, the length of the first heating line 101 in the first display sub-area A1 can be designed first, and then, using the length of the first heating line 101 as a reference, the second heating line 102 in the second display sub-area A2 is designed with a zigzag shape, and the lengths of the second heating line 102 and the first heating line 101 are approximately equal to each other and the areas of the display areas corresponding to the enclosed regions are approximately equal to each other, thereby improving the heating uniformity of the display panel.

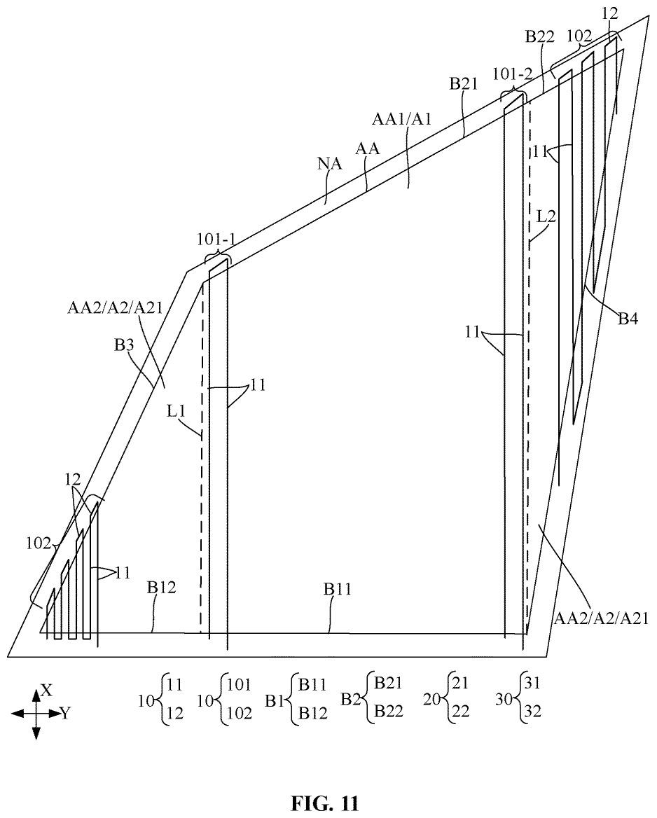

Regardless of whether the display area AA includes only the first display sub-area A1 and the first-type second display sub-area A21, or only the first display sub-area A1 and the second-type second display sub-area A22, or includes the first display sub-area A1, the first-type second display sub-area A21, and the second-type second display sub-area A22, in another optional embodiment, as shown in FIG. 11, which shows a schematic structural diagram of another display panel according to an embodiment of the present disclosure, it can be seen that the first edge B1 and the second edge B2 of the display area AA are non-parallel with each other. In this case, not only the second display sub-area A2 is a non-rectangular irregularly-shaped area AA2, but the first display sub-area A1 is also a non-rectangular irregularly-shaped area AA2. The first heating lines 101 with the same layout in the first display sub-area A1 also have different lengths, thereby causing the issues of different resistances and different heating powers. In this case, the second heating line 102 in the second display sub-area A 2 can also adopt a zigzag design, while the first heating line 101 in the first display sub-area A1 can refer to the heating line design in FIG. 3. In one embodiment, in the first display sub-area A1, the number of the first sub-segments 11 of each first heating line 101 is the same, for example, each first heating line 101 includes two first sub-segments 11. The first heating line 101 includes a first-type first heating line 101-1 and a second-type first heating line 101-2. The average length of the first sub-segments 11 in the second-type first heating line 101-2 is smaller than the average length of the first sub-segments 11 in the first-type first heating line 101-1. The arrangement density of the first sub-segments 11 along the second direction Y in the second-type first heating line 101-2 is smaller than the arrangement density of the first sub-segments 11 along the second direction Y in the first-type first heating line 101-1.

That is to say, although the average lengths of the first sub-segments 11 of the first-type first heating line 101-1 and the second-type first heating line 101-2 in the first display sub-area A1 are different from each other, by adjusting the arrangement densities of the first sub-segments 11 in the first-type first heating line 101-1 and the second-type first heating line 101-2, in one embodiment, adjusting the spacing of the first sub-segments 11 in the first-type first heating line 101-1 and the second-type first heating line 101-2, the lengths of the first-type first heating line 101-1 and the second-type first heating line 101-2 are made approximately equal to each other. Thus, the heating powers of the first-type first heating line 101-1 and the second-type first heating line 101-2 are approximately equal to each other. It can also make the areas of the display areas corresponding to the regions enclosed by the first-type first heating line 101-1 and the second-type first heating line 101-2 approximately equal to each other, thereby improving the heating uniformity of the display panel.

The display panel includes sub-pixels arranged in an array along a row direction and a column direction. The display panel further includes multiple gate lines and multiple data lines, the gate line extends along the row direction, and the data line extends along the column direction. The gate lines and data lines intersect to form an accurate addressing matrix, independently and controllably charging each sub-pixel and displaying an image by combining the sub-pixels. After adding heating lines to the display panel to heat the corresponding regions, the film layers and positions where the heating lines, gate lines, and data lines are located need to be appropriately set. The following describes the specific arrangement of the heating lines, gate lines, and data lines in the display panel, where the part of the heating line 10 located in the display area AA is located in the same metal layer, and the following mainly describes the arrangement of the heating line 10 located in the display area AA.

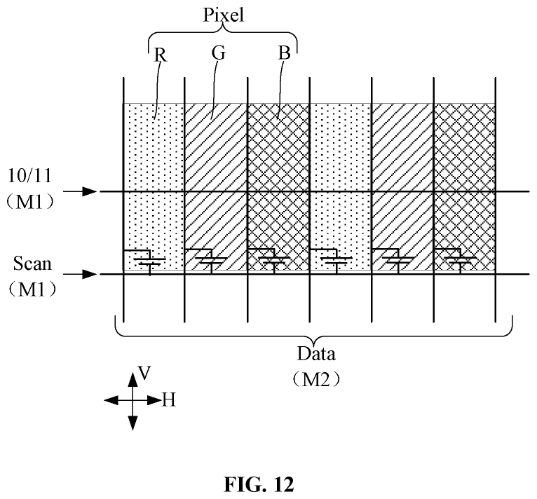

In some embodiments of the present disclosure, as shown in FIG. 12 to FIG. 16, FIG. 12 to FIG. 16 show schematic partial structural diagrams of five more display panels according to the present disclosure. It can be seen that the display panel includes sub-pixels Pixel arranged in an array along a row direction H and a column direction V. The display panel further includes multiple gate lines Scan and multiple data lines Data. The gate lines Scan extend along the row direction H, and the data lines Data extend along the column direction V. A row of sub-pixels Pixel is electrically connected to at least one gate line Scan, and at least one column of sub-pixels Pixel is electrically connected to one data line Data. The extension direction of the first sub-segment 11 in the heating line 10 is the same as the extension direction of the gate line Scan, i.e., the first sub-segment 11 in the heating line 10 extends along the row direction H, with reference to FIG. 6. In this way, the heating line 10 in the display area AA can be routed out along the row direction H and directly connected to the heating flexible circuit board FPC1 to obtain a heating signal and perform heating.

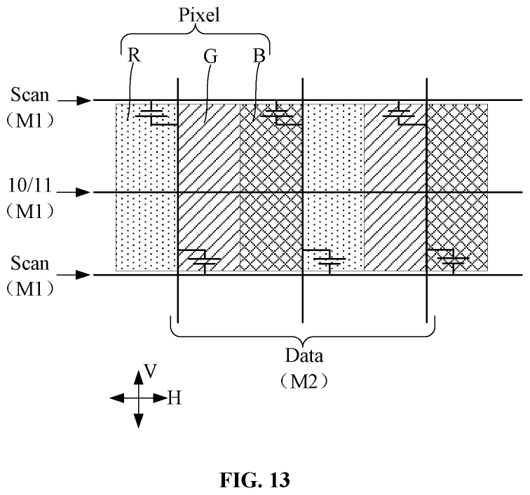

On the basis of setting the extension direction of the first sub-segment 11 in the heating line 10 to be the same as the extension direction of the gate line Scan, in some embodiments of the present disclosure, as shown in FIG. 12 and FIG. 13, the display panel includes a substrate and a first metal layer M1 and a second metal layer M2 stacked on a side of the substrate. The gate line Scan is located in the first metal layer M1, the data line Data is located in the second metal layer M2, and the heating line 10 is located in the first metal layer M1. That is, the heating line 10 and the gate line Scan can be arranged in the same direction and the same layer, both located in the first metal layer M1. Furthermore, the first sub-segment 11 of the heating line 10 can be located between at least a subset of adjacent gate lines Scan. According to the arrangement density of the first sub-segments 11 of each heating line 10, the first sub-segment 11 of the heating line 10 can be located between all adjacent gate lines Scan, or between a subset of the adjacent gate lines Scan. Moreover, since the first sub-segment 11 of the heating line 10 is located between at least a subset of the adjacent gate lines Scan, and the gate line Scan is usually located on one side of a row of sub-pixels Pixel along the column direction V, in a direction perpendicular to the plane of the substrate, the first sub-segment 11 of the heating line 10 overlaps with a row of sub-pixels Pixel.

In one embodiment, as shown in FIG. 12 and FIG. 13, any two adjacent sub-pixels Pixel in a row of sub-pixels Pixel have different emission colors. For example, the row of sub-pixels Pixel is periodically arranged in the order of a red sub-pixel R, a green sub-pixel G, and a blue sub-pixel B. In addition, each sub-pixel Pixel in a column of sub-pixels Pixel has the same emission color. For example, the column of sub-pixels Pixel can be a red sub-pixel column, a green sub-pixel column, or a blue sub-pixel column.

In one embodiment, as shown in FIG. 12, a row of sub-pixels Pixel may be electrically connected to one gate line Scan, i.e., the sub-pixels Pixel adopt a single gate line architecture. In addition, a column of sub-pixels Pixel is electrically connected to one data line Data. In one embodiment, the sub-pixel Pixel may include an independent thin-film transistor (TFT) for switching control. When a row of sub-pixels Pixel is scanned, the voltage signal on the gate line Scan corresponding to the row of sub-pixels Pixel turns on the thin-film transistor in the row of sub-pixels Pixel, and the voltage signal on the data line Data charges the capacitor of the row of sub-pixels Pixel through the turned-on thin-film transistor. After the charging is completed, the voltage signal on the gate line Scan turns off the thin-film transistor in the row of sub-pixels Pixel, and the voltage signal on the data line Data is maintained in the row of sub-pixels Pixel until the next frame refresh.

In one embodiment, as shown in FIG. 13, a row of sub-pixels Pixel may be electrically connected to two gate lines Scan, i.e., the sub-pixels Pixel adopt a dual gate line architecture. The two gate lines Scan electrically connected to the row of sub-pixels Pixel may be located on two sides of the row of sub-pixels Pixel along the column direction V. In one embodiment, the sub-pixel Pixel includes an independent thin-film transistor (TFT) for switching control. Each two adjacent sub-pixels Pixel in a row of sub-pixels Pixel are respectively electrically connected to different gate lines Scan. That is to say, the row of sub-pixels Pixel is electrically connected to two gate lines Scan in total, and, one of each two adjacent sub-pixels Pixel in a row of sub-pixels Pixel is electrically connected to one gate line Scan, and the other is electrically connected to the other gate line Scan. In this way, each two adjacent sub-pixels Pixel in a row of sub-pixels Pixel can share the data line Data. In this case, for each two adjacent sub-pixels Pixel in a row of sub-pixels Pixel, for example, adjacent red sub-pixel R and green sub-pixel G, within a time period 1, the gate line Scan controlling the red sub-pixel R is activated, and the voltage signal on the data line Data only charges the capacitor of the red sub-pixel R. Within a time period 2, the gate line Scan controlling the green sub-pixel G is activated, and the voltage signal on the data line Data only charges the capacitor of the green sub-pixel G. Thus, each two adjacent sub-pixels Pixel in a row of sub-pixels Pixel share one data line Data in a time-division manner, which can greatly reduce the number of data lines Data in the display panel.

With the same display panel resolution, if the sub-pixels Pixel in the display panel adopt a dual gate line architecture, compared with adopting a single gate line architecture, the number of gate lines Scan increases, making the charging time of each row of sub-pixels Pixel shorter.

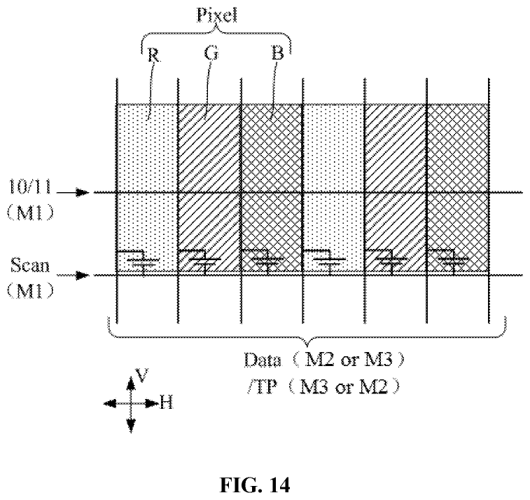

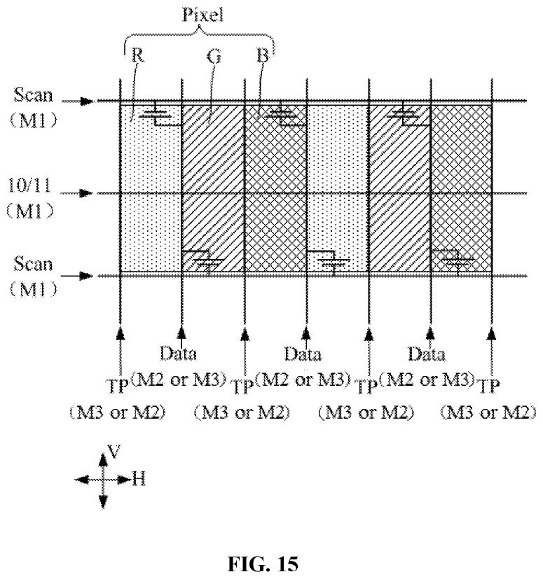

On the basis of setting the extension direction of the first sub-segment 11 in the heating line 10 to be the same as the extension direction of the gate line Scan, if it is further desired that the display panel has a touch control function, the display panel further includes multiple touch control lines. In this case, in some embodiments of the present disclosure, as shown in FIG. 14 and FIG. 15, the extension direction of the touch control line TP in the display panel can be set to be the same as the extension direction of the data line Data. In this case, the display panel may include a substrate and a first metal layer M1, a second metal layer M2, and a third metal layer M3 stacked on a side of the substrate. The gate line Scan is located in the first metal layer M1, the data line Data and the touch control line TP are respectively located in the second metal layer M2 and the third metal layer M3, and the heating line 10 is located in the first metal layer M1. That is, the heating line 10 and the gate line Scan are arranged in the same direction and the same layer, both located in the first metal layer M1. Furthermore, the first sub-segment 11 of the heating line 10 can be located between at least a subset of adjacent gate lines Scan. According to the arrangement density of the first sub-segments 11 of each heating line 10, the first sub-segment 11 of the heating line 10 can be located between all adjacent gate lines Scan, or between a subset of adjacent gate lines Scan. Since the first sub-segment 11 of the heating line 10 is located between at least a subset of adjacent gate lines Scan, and the gate line Scan is generally located on one side of a row of sub-pixels Pixel along the column direction V, in a direction perpendicular to the plane of the substrate, the first sub-segment 11 of the heating line 10 overlaps with the row of sub-pixels Pixel.

In one embodiment, as shown in FIG. 14 and FIG. 15, each two adjacent sub-pixels Pixel in a row of sub-pixels Pixel have different emission colors. For example, the row of sub-pixels Pixel is periodically arranged in the order of a red sub-pixel R, a green sub-pixel G, and a blue sub-pixel B. In addition, each sub-pixel Pixel in a column of sub-pixels Pixel has the same emission color. For example, the column of sub-pixels Pixel can be a red sub-pixel column, a green sub-pixel column, or a blue sub-pixel column.

Further in one embodiment, as shown in FIG. 14, a row of sub-pixels Pixel may be electrically connected to one gate line Scan, i.e., the sub-pixels Pixel adopt a single gate line architecture. In addition, a column of sub-pixels Pixel is electrically connected to one data line Data. When the voltage signal on the gate line Scan corresponding to the row of sub-pixels Pixel turns on the thin-film transistor in the row of sub-pixels Pixel, the voltage signal on the data line Data charges the capacitor of the row of sub-pixels through the turned-on thin-film transistor. In this case, since the data line Data and the touch control line TP are arranged in different layers (respectively located in the second metal layer M2 and the third metal layer M3), in a direction perpendicular to the plane of the substrate, the data line Data and the touch control line TP can at least partially overlap with each other, thereby reducing the space occupied by signal lines extending along the column direction V, which is beneficial for improving pixel density and resolution.

In one embodiment, as shown in FIG. 15, a row of sub-pixels Pixel may be electrically connected to two gate lines Scan, i.e., the sub-pixels Pixel adopt a dual gate line architecture. The two gate lines Scan electrically connected to the row of sub-pixels Pixel may be located on two sides of the row of sub-pixels Pixel along the column direction V. In this way, each two adjacent sub-pixels Pixel in the row of sub-pixels Pixel can be electrically connected to different gate lines Scan and electrically connected to the same data line Data. That is, each two adjacent sub-pixels Pixel in a row of sub-pixels Pixel share one data line Data in a time-division manner under the control of voltage signals of different gate lines Scan, and the number of data lines Data can be greatly reduced. Moreover, since the number of data lines Data is greatly reduced, there is sufficient space between adjacent data lines Data, and the data line Data and the touch control line TP are arranged in different layers (respectively located in the second metal layer M2 and the third metal layer M3), the orthographic projection of the touch control line TP on the plane of the substrate can be set to be located between the orthographic projections of two adjacent data lines Data on the plane of the substrate, and the data lines Data and the touch control lines TP extending along the column direction V are alternately and uniformly arranged, improving the wiring uniformity of the display panel. In another optional embodiment, in a direction perpendicular to the plane of the substrate, the data line Data and the touch control line TP can, in one embodiment, at least partially overlap with each other, thereby reducing the space occupied by signal lines, which is beneficial for improving pixel density and resolution.

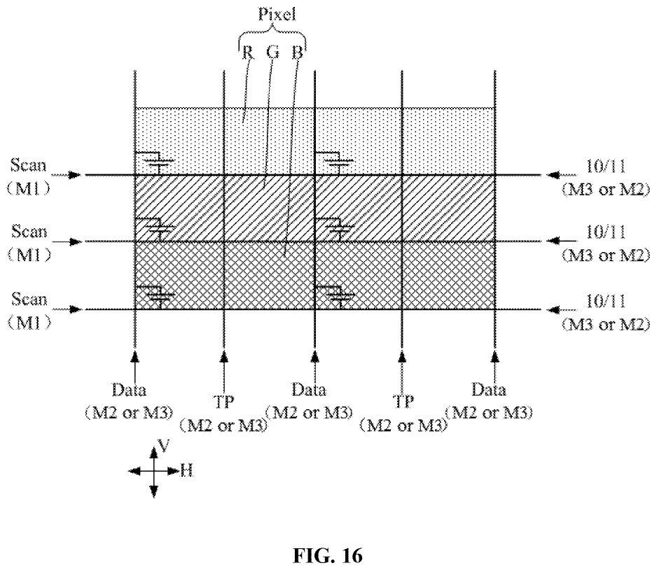

On the basis of setting the extension direction of the first sub-segment 11 in the heating line 10 to be the same as the extension direction of the gate line Scan, and the display panel further including multiple touch control lines to have a touch control function, in some embodiments of the present disclosure, as shown in FIG. 16, the extension direction of the touch control line TP in the display panel is the same as the extension direction of the data line Data. Moreover, the display panel includes a substrate and a first metal layer M1, a second metal layer M2, and a third metal layer M3 stacked on a side of the substrate. The gate line Scan is located in the first metal layer M1, the data line Data and the touch control line TP are located in the same one of the second metal layer M2 and the third metal layer M3, and the heating line 10 is located in the other one of the second metal layer M2 and the third metal layer M3. That is to say, the gate line Scan and the first sub-segment 11 of the heating line 10 are arranged in the same direction but different layers, and the data line Data and the touch control line TP are arranged in the same direction and the same layer.

Since the gate line Scan and the first sub-segment 11 of the heating line 10 are arranged in the same direction but different layers, in one embodiment, as shown in FIG. 16, in a direction perpendicular to the plane of the substrate, the first sub-segment 11 of the heating line 10 and the gate line Scan can at least partially overlap with each other, thereby reducing the space occupied by signal lines extending along the row direction H, which is beneficial for improving pixel density and resolution.

In one embodiment, as shown in FIG. 16, each sub-pixel Pixel in a row of sub-pixels Pixel has the same emission color, and each two adjacent sub-pixels Pixel in a column of sub-pixels Pixel have different emission colors. For example, the column of sub-pixels Pixel is periodically arranged in the order of a red sub-pixel R, a green sub-pixel G, and a blue sub-pixel B. In this case, a row of sub-pixels Pixel can be set to be electrically connected to one gate line Scan, and a column of sub-pixels Pixel is electrically connected to one data line Data. When the voltage signal on the gate line Scan corresponding to a row of sub-pixels Pixel turns on the thin-film transistor in the row of sub-pixels Pixel, the voltage signal on the data line Data charges the capacitor of the row of sub-pixels through the turned-on thin-film transistor. Moreover, the touch control line TP is located between two adjacent data lines Data in the same layer. Since the data line Data is generally located on one side of a column of sub-pixels Pixel along the row direction H, in a direction perpendicular to the plane of the substrate, the touch control line TP overlaps with the column of sub-pixels Pixel.

As shown in FIG. 12 to FIG. 16, when the extension direction of the first sub-segment 11 in the heating line 10 is the same as the extension direction of the gate line Scan, in a direction perpendicular to the plane of the substrate, the first sub-segment 11 in the heating line 10 at least partially overlaps with a row of sub-pixels Pixel or the gate line Scan. The linewidth of the first sub-segment 11 in the heating line 10 may be equal to the linewidth of the data line Data, to avoid affecting the light transmittance of the display panel due to the heating line 10 being too wide and requiring more shielding structures for shielding.

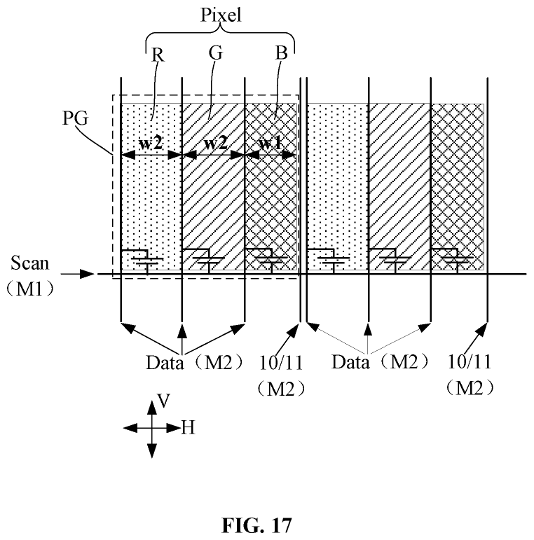

Regarding the arrangement of the heating lines, gate lines, and data lines in the display panel, in some embodiments of the present disclosure, as shown in FIG. 17 to FIG. 22, FIG. 17 to FIG. 22 show schematic partial structural diagrams of six more display panels according to the present disclosure. It can be seen that the display panel includes sub-pixels Pixel arranged in an array along a row direction H and a column direction V. The display panel further includes multiple gate lines Scan and multiple data lines Data, the gate lines Scan extend along the row direction H, and the data lines Data extend along the column direction V. A row of sub-pixels Pixel is electrically connected to at least one gate line Scan, and at least one column of sub-pixels Pixel is electrically connected to one data line Data. The extension direction of the first sub-segment 11 in the heating line 10 is the same as the extension direction of the data line Data, i.e., the first sub-segment 11 in the heating line 10 extends along the column direction V, with reference to FIG. 1, FIG. 3, FIG. 4 to FIG. 5, and FIG. 7 to FIG. 11. In this way, the heating line 10 in the display area AA can be routed out longitudinally, directly connected to the heating flexible circuit board FPC1, or first connected to the peripheral positive heating bus 20 and negative heating bus 30, and then connected to the heating flexible circuit board FPC1 to obtain a heating signal and perform heating.

On the basis of setting the extension direction of the first sub-segment 11 in the heating line 10 to be the same as the extension direction of the data line Data, in some embodiments of the present disclosure, as shown in FIG. 17 to FIG. 19, the display panel includes a substrate and a first metal layer M1 and a second metal layer M2 stacked on a side of the substrate. The gate line Scan is located in the first metal layer M1, the data line Data is located in the second metal layer M2, and the heating line 10 is also located in the second metal layer M2. That is, the heating line 10 and the data line Data are arranged in the same layer, but the heating line 10 needs to be insulated from the data line Data to avoid signal interference.

In the case where the extension direction of the first sub-segment 11 in the heating line 10 is the same as the extension direction of the data line Data, and the heating line 10 and the data line Data are arranged in the same layer insulated from each other, in some embodiments of the present disclosure, as shown in FIG. 17, each two adjacent sub-pixels Pixel in a row of sub-pixels Pixel have different emission colors. For example, the row of sub-pixels Pixel is periodically arranged in the order of a red sub-pixel R, a green sub-pixel G, and a blue sub-pixel B. In addition, each sub-pixel Pixel in a column of sub-pixels Pixel has the same emission color. For example, the column of sub-pixels Pixel is a red sub-pixel column, a green sub-pixel column, or a blue sub-pixel column. Moreover, the display panel may include multiple columns of pixel groups PG. A column of pixel groups PG includes three columns of sub-pixels Pixel, and the emission colors of the three columns of sub-pixels Pixel are different from each other. For example, the column of pixel groups PG includes three columns of sub-pixels: a red sub-pixel column, a green sub-pixel column, and a blue sub-pixel column. In this case, a row of sub-pixels Pixel may be electrically connected to one gate line Scan, i.e., the sub-pixels Pixel adopt a single gate line architecture. In addition, a column of sub-pixels Pixel is electrically connected to one data line Data, and the data line Data electrically connected to the column of sub-pixels Pixel is located on one side of the column of sub-pixels Pixel along the row direction H. When the voltage signal on the gate line Scan corresponding to a row of sub-pixels Pixel turns on the thin-film transistor in the row of sub-pixels Pixel, the voltage signal on the data line Data charges the capacitor of the row of sub-pixels through the turned-on thin-film transistor. The first sub-segment 11 of the heating line 10 is located between at least a subset of adjacent columns of pixel groups PG.

As shown in FIG. 17, since a column of sub-pixels Pixel is electrically connected to one data line Data, and the data line Data electrically connected to a column of sub-pixels Pixel is located on one side of the column of sub-pixels Pixel along the row direction H, when the first sub-segment 11 of the heating line 10 is located between at least a subset of adjacent columns of pixel groups PG, the first sub-segment 11 of the heating line 10 is located between two adjacent columns of sub-pixels Pixel. That is to say, both the data line Data and the first sub-segment 11 of the heating line 10 are arranged between at least a subset of adjacent columns of sub-pixels Pixel. To arrange both the data line Data and the first sub-segment 11 of the heating line 10 between at least a subset of adjacent columns of sub-pixels Pixel, the width of at least a subset of sub-pixel columns can be reduced, and the space between the at least a subset of adjacent columns of sub-pixels Pixel is sufficient to accommodate both the data line Data and the first sub-segment 11 of the heating line 10.

For example, as shown in FIG. 17, the pixel group PG includes a red sub-pixel R, a green sub-pixel G, and a blue sub-pixel B sequentially arranged along the row direction H. It can be imagined that the pixel groups PG are arranged along the column direction V to form a column of pixel groups PG, and columns of pixel groups PG are arranged along the row direction H, i.e., the pixel groups PG are arranged in an array along the row direction H and the column direction V. In this way, the blue sub-pixel column (i.e., a column formed by arranging blue sub-pixels B along the column direction V) in one column of pixel groups PG is adjacent to the red sub-pixel column (i.e., a column formed by arranging red sub-pixels R along the column direction V) in another column of pixel groups PG. In this case, the width of the blue sub-pixel column (i.e., a column formed by arranging blue sub-pixels B along the column direction V) in a column of pixel groups PG can be reduced, and the space between this column of pixel groups PG and the adjacent another column of pixel groups PG is sufficient to accommodate both the data line Data and the first sub-segment 11 of the heating line 10, which is not limited in the present disclosure. In practice, the red sub-pixel column (i.e., a column formed by arranging red sub-pixels R along the column direction V) or the green sub-pixel column (i.e., a column formed by arranging green sub-pixels G along the column direction V) in a column of pixel groups PG can be, in one embodiment, compressed, and the space between this column of pixel groups PG and the adjacent another column of pixel groups PG is sufficient to accommodate both the data line Data and the first sub-segment 11 of the heating line 10.

In one embodiment, as shown in FIG. 17, in a column of pixel groups PG, the width w1 of a column of sub-pixels Pixel, on a side of which the first sub-segment 11 of the heating line 10 is arranged along the row direction H, is smaller than the width w2 of any other column of sub-pixels Pixel. That is, the width of the column of sub-pixels Pixel in a column of pixel groups PG, on a side of which the first sub-segment 11 of the heating line 10 is arranged along the row direction H, is reduced, and the space between this column of pixel groups PG and the adjacent another column of pixel groups PG is sufficient to accommodate both the data line Data and the first sub-segment 11 of the heating line 10.

In addition, the first sub-segment 11 of the heating line 10 can be set to be located between all adjacent columns of pixel groups PG, or between a subset of adjacent columns of pixel groups PG, according to the arrangement density of the first sub-segments 11 of the heating line 10 in the display area AA.

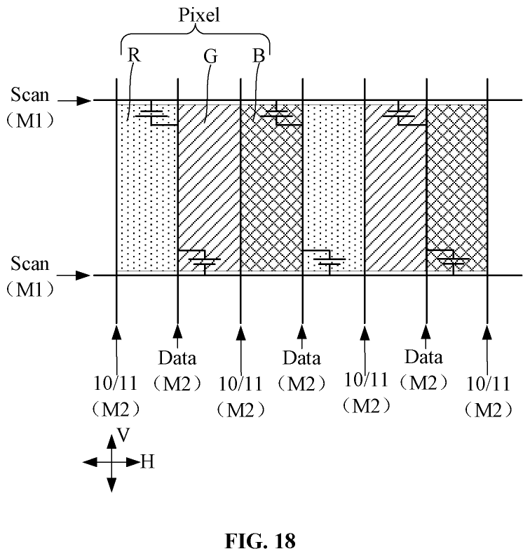

In the case where the extension direction of the first sub-segment 11 in the heating line 10 is the same as the extension direction of the data line Data, and the heating line 10 and the data line Data are arranged in the same layer and insulated from each other, in some embodiments of the present disclosure, as shown in FIG. 18, each two adjacent sub-pixels Pixel in a row of sub-pixels Pixel have different emission colors. For example, the row of sub-pixels Pixel is periodically arranged in the order of a red sub-pixel R, a green sub-pixel G, and a blue sub-pixel B. In addition, each sub-pixel Pixel in a column of sub-pixels Pixel has the same emission color. For example, the column of sub-pixels Pixel is a red sub-pixel column, a green sub-pixel column, or a blue sub-pixel column. In this case, a row of sub-pixels Pixel may be electrically connected to two gate lines Scan, i.e., the sub-pixels Pixel adopt a dual gate line architecture. The two gate lines Scan electrically connected to the row of sub-pixels Pixel may be located on two sides of the row of sub-pixels Pixel along the column direction V. In this way, each two adjacent sub-pixels Pixel in the row of sub-pixels Pixel can be electrically connected to different gate lines Scan and electrically connected to the same data line Data. That is, each two adjacent sub-pixels Pixel in a row of sub-pixels Pixel share one data line Data in a time-division manner under the control of voltage signals of different gate lines Scan, and the number of data lines Data can be greatly reduced. Moreover, since the number of data lines Data is greatly reduced, there is sufficient space between adjacent data lines Data, and the first sub-segment 11 of the heating line 10 and the data line Data are arranged in the same layer and the same direction and insulated from each other, the orthographic projection of the first sub-segment 11 of the heating line 10 on the plane of the substrate can be set to be located between the orthographic projections of at least a subset of adjacent data lines Data on the plane of the substrate. According to the arrangement density of the first sub-segments 11 of each heating line 10 in the display area AA, the orthographic projection of the first sub-segment 11 of the heating line 10 on the plane of the substrate is located between the orthographic projections of all adjacent data lines Data on the plane of the substrate, or between the orthographic projections of a subset of the adjacent data lines Data on the plane of the substrate.

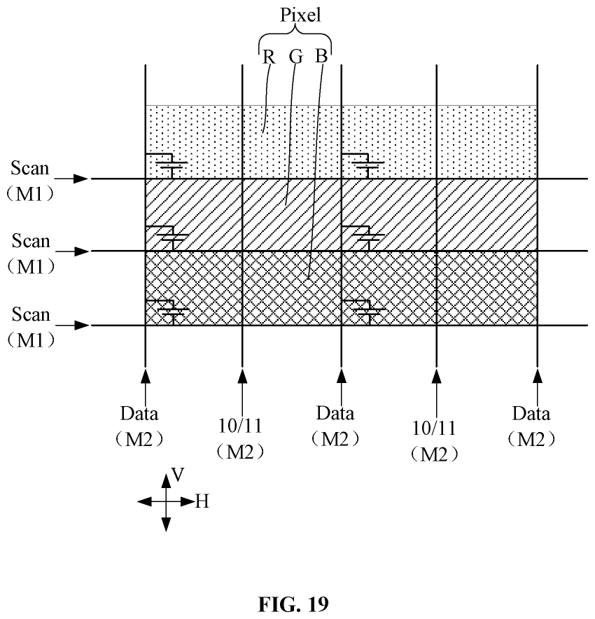

In the case where the extension direction of the first sub-segment 11 in the heating line 10 is the same as the extension direction of the data line Data, and the heating line 10 and the data line Data are arranged in the same layer and insulated from each other, optionally, in some embodiments of the present disclosure, as shown in FIG. 19, each sub-pixel Pixel in a row of sub-pixels Pixel has the same emission color, and each two adjacent sub-pixels Pixel in a column of sub-pixels Pixel have different emission colors. For example, the column of sub-pixels Pixel is periodically arranged in the order of a red sub-pixel R, a green sub-pixel G, and a blue sub-pixel B. A row of sub-pixels Pixel is a red sub-pixel row, a green sub-pixel row, or a blue sub-pixel row. In this case, a row of sub-pixels Pixel may be electrically connected to one gate line Scan, i.e., the sub-pixels Pixel adopt a single gate line architecture. In addition, a column of sub-pixels Pixel is electrically connected to one data line Data. When the voltage signal on the gate line Scan corresponding to a row of sub-pixels Pixel turns on the thin-film transistor in the row of sub-pixels Pixel, the voltage signal on the data line Data charges the capacitor of the row of sub-pixels through the turned-on thin-film transistor. In this way, since the first sub-segment 11 of the heating line 10 and the data line Data are arranged in the same layer and the same direction and insulated from each other, the first sub-segment 11 of the heating line 10 can be set to be located between at least a subset of adjacent data lines Data. In a direction perpendicular to the plane of the substrate, the first sub-segment 11 of the heating line 10 overlaps with a column of sub-pixels Pixel. In this way, the signal lines extending along the column direction V are arranged more uniformly, improving the wiring uniformity of the display panel.

The first sub-segment 11 of the heating line 10 can be located between all adjacent data lines Data, or between a subset of adjacent data lines Data, according to the arrangement density of the first sub-segments 11 of each heating line 10 in the display area AA.

It can also be understood that when the sub-pixels Pixel of the display panel are arranged as shown in FIG. 19, i.e., each sub-pixel Pixel in a row of sub-pixels Pixel has the same emission color, and each two adjacent sub-pixels Pixel in a column of sub-pixels Pixel have different emission colors, the size of the sub-pixel Pixel along the row direction H can be larger than the size of the sub-pixel along the column direction V. Moreover, the data line Data electrically connected to a column of sub-pixels Pixel can be located on a side of the column of sub-pixels Pixel along the row direction H. Thus, the distance between two adjacent data lines Data is basically the size of one column of sub-pixels along the row direction H, i.e., there is sufficient space between adjacent two data lines Data to accommodate the first sub-segment 11 of the heating line 10.

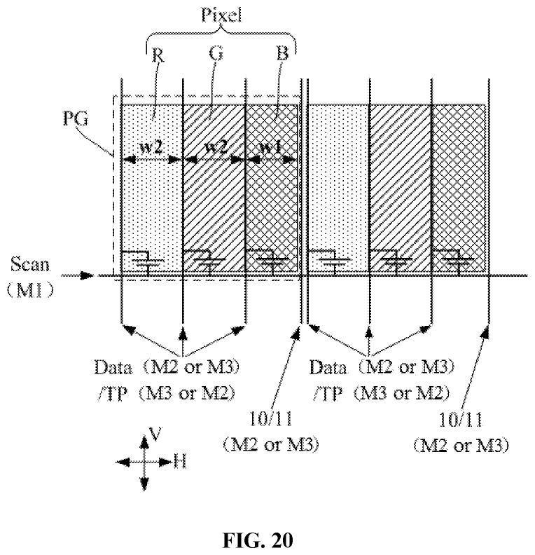

On the basis of setting the extension direction of the first sub-segment 11 in the heating line 10 to be the same as the extension direction of the data line Data, if it is further desired that the display panel has a touch control function, the display panel further includes multiple touch control lines. In this case, in some embodiments of the present disclosure, as shown in FIG. 20 to FIG. 25, FIG. 20 to FIG. 25 show schematic partial structural diagrams of six more display panels according to the present disclosure. The extension direction of the touch control line TP in the display panel can be set to be the same as the extension direction of the data line Data, i.e., the data line Data, the touch control line TP, and the first sub-segment 11 in the heating line 10 in the display panel all extend along the column direction V. In this case, the display panel may include a substrate and a first metal layer M1, a second metal layer M2, and a third metal layer M3 stacked on a side of the substrate. The gate line Scan is located in the first metal layer M1, the data line Data and the touch control line TP are respectively located in the second metal layer M2 and the third metal layer M3, and the heating line 10 is located in the second metal layer M2 or the third metal layer M3. That is, the first sub-segment 11 in the heating line 10 and the data line Data are arranged in the same layer and the same direction and insulated from each other, or the first sub-segment 11 in the heating line 10 and the touch control line TP are arranged in the same layer and the same direction and insulated from each other.

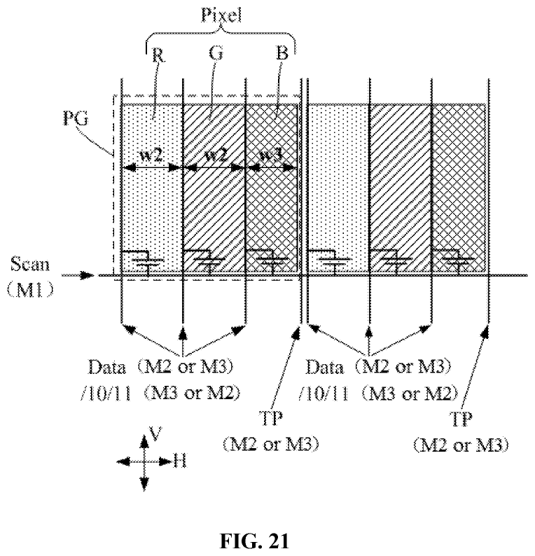

On this basis, in one embodiment, as shown in FIG. 20 and FIG. 21, each two adjacent sub-pixels Pixel in a row of sub-pixels Pixel have different emission colors. For example, the row of sub-pixels Pixel is periodically arranged in the order of a red sub-pixel R, a green sub-pixel G, and a blue sub-pixel B. In addition, each sub-pixel Pixel in a column of sub-pixels Pixel has the same emission color. For example, the column of sub-pixels Pixel is a red sub-pixel column, a green sub-pixel column, or a blue sub-pixel column. Moreover, the display panel may include multiple columns of pixel groups PG. A column of pixel groups PG includes three columns of sub-pixels Pixel, and the emission colors of the three columns of sub-pixels Pixel are different from each other. For example, the column of pixel groups PG includes three columns of sub-pixels: a red sub-pixel column, a green sub-pixel column, and a blue sub-pixel column. In this case, a row of sub-pixels Pixel may be electrically connected to one gate line Scan, i.e., the sub-pixels Pixel adopt a single gate line architecture. In addition, a column of sub-pixels Pixel is electrically connected to one data line Data, and the data line Data electrically connected to the column of sub-pixels Pixel is located on a side of the column of sub-pixels Pixel along the row direction H. When the voltage signal on the gate line Scan corresponding to a row of sub-pixels Pixel turns on the thin-film transistor in the row of sub-pixels Pixel, the voltage signal on the data line Data charges the capacitor of the row of sub-pixels through the turned-on thin-film transistor.

Further in one embodiment, as shown in FIG. 20, since the data line Data and the touch control line TP are arranged in the same direction but different layers, and the first sub-segment 11 in the heating line 10 is arranged in the same direction and the same layer as the data line Data or the touch control line TP, it can be set that in a direction perpendicular to the plane of the substrate, the touch control line TP at least partially overlaps with the data line Data, and the first sub-segment 11 of the heating line 10 is located between at least a subset of adjacent columns of pixel groups PG.

In another optional embodiment, as shown in FIG. 21, since the data line Data and the touch control line TP are arranged in the same direction but different layers, and the first sub-segment 11 in the heating line 10 is arranged in the same direction and the same layer as the data line Data or the touch control line TP, it can also be set that in a direction perpendicular to the plane of the substrate, the first sub-segment 11 of the heating line 10 overlaps with at least a subset of the data lines Data, and the touch control line TP is located between adjacent two columns of pixel groups PG.

As shown in FIG. 20, since a column of sub-pixels Pixel is electrically connected to one data line Data, and the data line Data electrically connected to the column of sub-pixels Pixel is located on one side of the column of sub-pixels Pixel along the row direction H, when the first sub-segment 11 of the heating line 10 is located between at least a subset of adjacent columns of pixel groups PG, the first sub-segment 11 of the heating line 10 is located between two adjacent columns of sub-pixels Pixel. That is to say, both the data line Data and the first sub-segment 11 of the heating line 10 are arranged between at least a subset of adjacent columns of sub-pixels Pixel. To arrange both the data line Data and the first sub-segment 11 of the heating line 10 between at least a subset of adjacent columns of sub-pixels Pixel, the width of at least a subset of sub-pixel columns can be reduced, and the space between the at least a subset of adjacent columns of sub-pixels Pixel is sufficient to accommodate both the data line Data and the first sub-segment 11 of the heating line 10.

Similarly, as shown in FIG. 21, since a column of sub-pixels Pixel is electrically connected to one data line Data, and the data line Data electrically connected to the column of sub-pixels Pixel is located on one side of the column of sub-pixels Pixel along the row direction H, when the touch control line TP is located between adjacent two columns of pixel groups PG, the touch control line TP is located between two adjacent columns of sub-pixels Pixel. That is to say, both the data line Data and the touch control line TP are arranged between at least a subset of adjacent columns of sub-pixels Pixel. To arrange both the data line Data and the touch control line TP between adjacent two columns of sub-pixels Pixel, the width of at least a subset of sub-pixel columns can be reduced, and the space between the adjacent two columns of sub-pixels Pixel is sufficient to accommodate both the data line Data and the touch control line TP.

For example, as shown in FIG. 20 and FIG. 21, the pixel group PG includes a red sub-pixel R, a green sub-pixel G, and a blue sub-pixel B sequentially arranged along the row direction H. It can be imagined that the pixel groups PG are arranged along the column direction V to form a column of pixel groups PG, and columns of pixel groups PG are arranged along the row direction H, i.e., the pixel groups PG are arranged in an array along the row direction H and the column direction V. In this way, the blue sub-pixel column (i.e., a column formed by arranging blue sub-pixels B along the column direction V) in one column of pixel groups PG is adjacent to the red sub-pixel column (i.e., a column formed by arranging red sub-pixels R along the column direction V) in another column of pixel groups PG. In this case, the width of the blue sub-pixel (i.e., a column formed by arranging blue sub-pixels B along the column direction V) column in the column of pixel groups PG can be reduced, and the space between this column of pixel groups PG and the adjacent another column of pixel groups PG is sufficient to accommodate both the data line Data and the first sub-segment 11 of the heating line 10, or to accommodate both the data line Data and the touch control line TP, which, however, is not limited in the present disclosure. In practice, the red sub-pixel column (i.e., a column formed by arranging red sub-pixels R along the column direction V) or the green sub-pixel column (i.e., a column formed by arranging green sub-pixels G along the column direction V) in the column of pixel groups PG can be, in one embodiment, compressed, and the space between this column of pixel groups PG and the adjacent another column of pixel groups PG is sufficient to accommodate both the data line Data and the first sub-segment 11 of the heating line 10, or to accommodate both the data line Data and the touch control line TP.

In one embodiment, as shown in FIG. 20, in a column of pixel groups PG, the width w1 of a column of sub-pixels Pixel, on one side of which the first sub-segment 11 of the heating line 10 is arranged along the row direction H, is smaller than the width w2 of any other column of sub-pixels Pixel. That is, the width of the column of sub-pixels Pixel in a column of pixel groups PG, on one side which the first sub-segment 11 of the heating line 10 is arranged along the row direction H, is reduced, and the space between this column of pixel groups PG and the adjacent another column of pixel groups PG is sufficient to accommodate both the data line Data and the first sub-segment 11 of the heating line 10, or to accommodate both the data line Data and the touch control line TP.

In addition, when the first sub-segment 11 of the heating line 10 is located between at least a subset of adjacent columns of pixel groups PG, the first sub-segment 11 of the heating line 10 can be set to be located between all adjacent columns of pixel groups PG, or between a subset of adjacent columns of pixel groups PG, according to the arrangement density of the first sub-segments 11 of each heating line 10 in the display area AA.

Similarly, as shown in FIG. 21, in a column of pixel groups PG, the width w3 of a column of sub-pixels Pixel, on one side of which the touch control line TP is arranged along the row direction H, is smaller than the width w2 of any other column of sub-pixels Pixel. That is, the width of the column of sub-pixels Pixel in a column of pixel groups PG, on one side of which the touch control line TP is arranged along the row direction H, is reduced, and the space between this column of pixel groups PG and the adjacent another column of pixel groups PG is sufficient to accommodate both the data line Data and the touch control line TP.

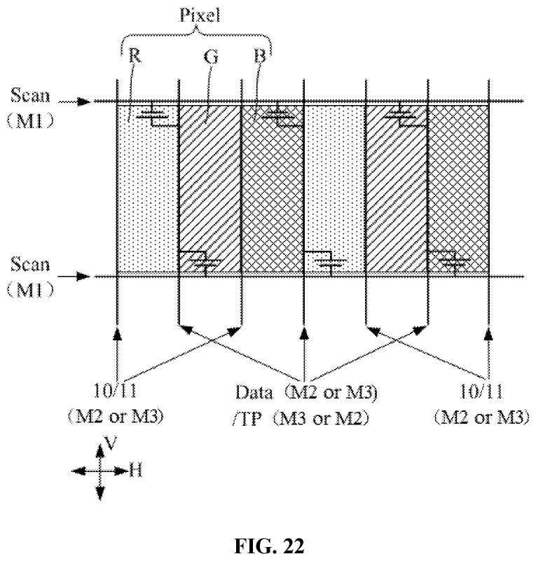

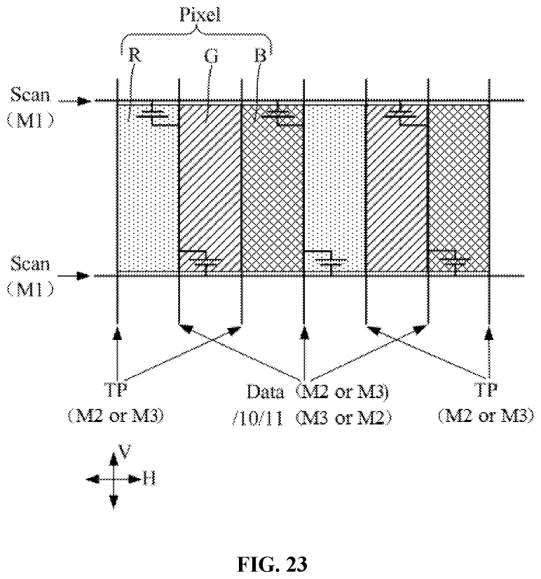

The first sub-segment 11 of the heating line 10, the data line Data, and the touch control line TP all extend along the column direction V, the display panel includes a substrate and a first metal layer M1, a second metal layer M2, and a third metal layer M3 stacked on a side of the substrate, the gate line Scan is located in the first metal layer M1, the data line Data and the touch control line TP are respectively located in the second metal layer M2 and the third metal layer M3, and the heating line 10 is located in the second metal layer M2 or the third metal layer M3, i.e., the first sub-segment 11 in the heating line 10 and the data line Data are arranged in the same layer and the same direction and insulated from each other, or the first sub-segment 11 in the heating line 10 and the touch control line TP are arranged in the same layer and the same direction and insulated from each other. In another optional embodiment, as shown in FIG. 22 and FIG. 23, each two adjacent sub-pixels Pixel in a row of sub-pixels Pixel have different emission colors. For example, the row of sub-pixels Pixel is periodically arranged in the order of a red sub-pixel R, a green sub-pixel G, and a blue sub-pixel B. In addition, each sub-pixel Pixel in a column of sub-pixels Pixel has the same emission color. For example, the column of sub-pixels Pixel is a red sub-pixel column, a green sub-pixel column, or a blue sub-pixel column. Moreover, a row of sub-pixels Pixel is electrically connected to two gate lines Scan, i.e., the sub-pixels Pixel adopt a dual gate line architecture. The two gate lines Scan electrically connected to a row of sub-pixels Pixel may be located on two sides of the row of sub-pixels Pixel along the column direction V. In this way, each two adjacent sub-pixels Pixel in the row of sub-pixels Pixel can be electrically connected to different gate lines Scan and electrically connected to the same data line Data. That is, each two adjacent sub-pixels Pixel in the row of sub-pixels Pixel share one data line Data in a time-division manner under the control of voltage signals of different gate lines Scan, and the number of data lines Data can be greatly reduced.

Since the number of data lines Data is greatly reduced, there is sufficient space between adjacent data lines Data. Therefore, further in one embodiment, as shown in FIG. 22, since the data line Data and the touch control line TP are arranged in the same direction but different layers, and the first sub-segment 11 in the heating line 10 is arranged in the same direction and the same layer as the data line Data or the touch control line TP, it can be set that in a direction perpendicular to the plane of the substrate, the touch control line TP at least partially overlaps with the data line Data, and the first sub-segment 11 of the heating line 10 is located between at least a subset of adjacent data lines Data. This can not only reduce the space occupied by signal lines extending along the column direction V, which is beneficial for improving pixel density and resolution, but also improve the distribution uniformity of signal lines extending along the column direction V.

Moreover, when the first sub-segment 11 of the heating line 10 is located between at least a subset of adjacent data lines Data, the first sub-segment 11 of the heating line 10 can be set to be located between all adjacent data lines Data, or between a subset of adjacent data lines Data, according to the arrangement density of the first sub-segments 11 of each heating line 10 in the display area AA.

In another optional embodiment, as shown in FIG. 23, since the data line Data and the touch control line TP are arranged in the same direction but different layers, and the first sub-segment 11 in the heating line 10 is arranged in the same direction and the same layer as the data line Data or the touch control line TP, it can be set that in a direction perpendicular to the plane of the substrate, the first sub-segment 11 of the heating line 10 overlaps with at least a subset of the data lines Data, and the touch control line TP is located between adjacent two data lines Data. This can not only reduce the space occupied by signal lines extending along the column direction V, which is beneficial for improving pixel density and resolution, but also improve the distribution uniformity of signal lines extending along the column direction V.

Moreover, when the first sub-segment 11 of the heating line 10 is set to overlap with at least a subset of the data lines Data in a direction perpendicular to the plane of the substrate, the first sub-segment 11 of the heating line 10 can be set to overlap with all data lines Data, or overlap with a subset of the data lines Data, according to the arrangement density of the first sub-segments 11 of each heating line 10 in the display area AA.

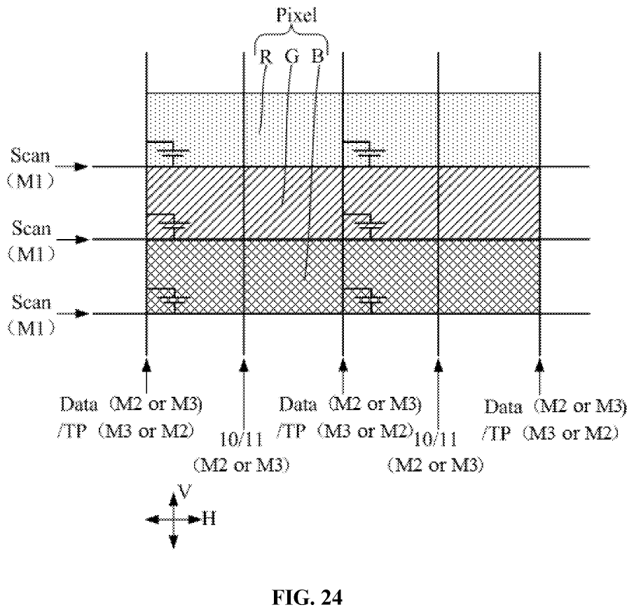

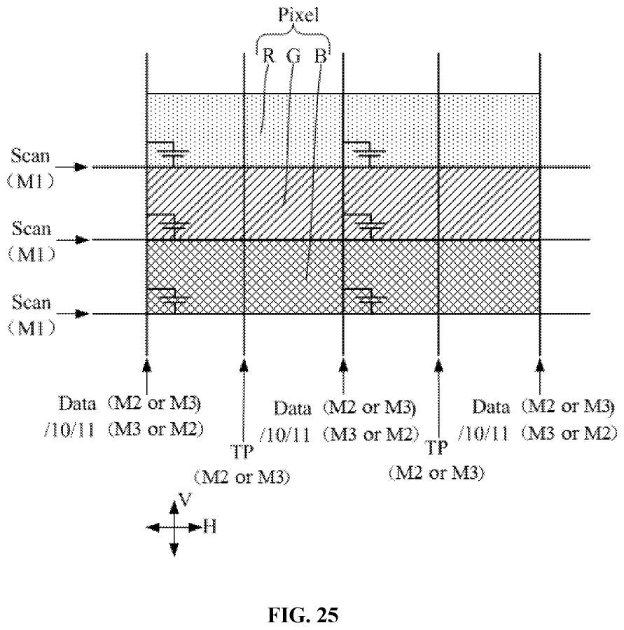

The first sub-segment 11 of the heating line 10, the data line Data, and the touch control line TP all extend along the column direction V, the display panel includes a substrate and a first metal layer M1, a second metal layer M2, and a third metal layer M3 stacked on a side of the substrate, the gate line Scan is located in the first metal layer M1, the data line Data and the touch control line TP are respectively located in the second metal layer M2 and the third metal layer M3, the heating line 10 is located in the second metal layer M2 or the third metal layer M3, i.e., the first sub-segment 11 in the heating line 10 and the data line Data are arranged in the same layer and the same direction and insulated from each other, or the first sub-segment 11 in the heating line 10 and the touch control line TP are arranged in the same layer and the same direction and insulated from each other. In another optional embodiment, as shown in FIG. 24 and FIG. 25, each sub-pixel Pixel in a row of sub-pixels Pixel has the same emission color, and each two adjacent sub-pixels Pixel in a column of sub-pixels Pixel have different emission colors. For example, the column of sub-pixels Pixel is periodically arranged in the order of a red sub-pixel R, a green sub-pixel G, and a blue sub-pixel B. The row of sub-pixels Pixel is a red sub-pixel row, a green sub-pixel row, or a blue sub-pixel row. In this case, a row of sub-pixels Pixel may be electrically connected to one gate line Scan, i.e., the sub-pixels Pixel adopt a single gate line architecture. In addition, a column of sub-pixels Pixel is electrically connected to one data line Data. When the voltage signal on the gate line Scan corresponding to the row of sub-pixels Pixel turns on the thin-film transistor in the row of sub-pixels Pixel, the voltage signal on the data line Data charges the capacitor of the row of sub-pixels through the turned-on thin-film transistor.

Further in one embodiment, as shown in FIG. 25, since the data line Data and the touch control line TP are arranged in the same direction but different layers, and the first sub-segment 11 in the heating line 10 is arranged in the same direction and the same layer as the data line Data or the touch control line TP, it can be set that the first sub-segment 11 of the heating line 10 is located between at least a subset of adjacent data lines Data, and in a direction perpendicular to the plane of the substrate, the first sub-segment 11 of the heating line 10 overlaps with a column of sub-pixels Pixel, and the touch control line TP at least partially overlaps with the data line Data. In this way, not only can the space occupied by signal lines extending along the column direction V be reduced, which is beneficial for improving pixel density and resolution, but also the distribution uniformity of signal lines extending along the column direction V can be improved.

The first sub-segment 11 of the heating line 10 can be located between all adjacent data lines Data, or between a subset of the adjacent data lines Data, according to the arrangement density of the first sub-segments 11 of each heating line 10 in the display area AA.

In another optional embodiment, as shown in FIG. 25, since the data line Data and the touch control line TP are arranged in the same direction but different layers, and the first sub-segment 11 in the heating line 10 is arranged in the same direction and the same layer as the data line Data or the touch control line TP, it can be set that the touch control line TP is located between adjacent two data lines Data, and in a direction perpendicular to the plane of the substrate, the touch control line TP overlaps with a column of sub-pixels Pixel, and the first sub-segment 11 of the heating line 10 overlaps with at least a subset of the data lines Data.

In a direction perpendicular to the plane of the substrate, the first sub-segment 11 of the heating line 10 overlaps with all data line Data, or overlaps with a subset of the data lines Data, according to the arrangement density of the first sub-segments 11 of each heating line 10 in the display area AA.

It can also be understood that when the sub-pixels Pixel of the display panel are arranged as shown in FIG. 24 and FIG. 25, i.e., each sub-pixel Pixel in a row of sub-pixels Pixel has the same emission color, and each two adjacent sub-pixels Pixel in a column of sub-pixels Pixel have different emission colors, the size of the sub-pixel Pixel along the row direction H can be larger than the size of the sub-pixel along the column direction V. Moreover, the data line Data electrically connected to a column of sub-pixels Pixel can be located on one side of the column of sub-pixels Pixel along the row direction H. Thus, the distance between two adjacent data lines Data is basically the size of one column of sub-pixels along the row direction H, i.e., there is sufficient space between adjacent two data lines Data to accommodate the first sub-segment 11 of the heating line 10 or the touch control line TP.

As shown in FIG. 17 to FIG. 25, when the extension direction of the first sub-segment 11 in the heating line 10 is the same as the extension direction of the data line Data, in a direction perpendicular to the plane of the substrate, the first sub-segment 11 in the heating line 10 at least partially overlaps with a column of sub-pixels Pixel or the data line Data. The linewidth of the first sub-segment 11 in the heating line 10 may be equal to the linewidth of the data line Data, to avoid affecting the light transmittance of the display panel due to the heating line 10 being too wide and requiring more shielding structures for shielding.

The arrangement of the gate line Scan, the data line Data, the first sub-segment 11 of the heating line 10, and the touch control line TP in the display area AA has been introduced above. The heating line 10 in the display area AA may be directly connected to a heating flexible circuit board, or the heating line 10 in the display area AA may be first connected to the positive heating bus 20 and the negative heating bus 30 located in the non-display area NA, and then connected to the heating flexible circuit board through the positive heating bus 20 and the negative heating bus 30. If the heating line 10 in the display area AA is directly connected to the heating flexible circuit board, a large number of pins of the heating flexible circuit board are required, and an independent heating flexible circuit board is needed; while if the heating line 10 in the display area AA is connected to the heating flexible circuit board through the positive heating bus 20 and the negative heating bus 30, the heating flexible circuit board only needs to reserve a small number of heating pins for the positive heating bus 20 and the negative heating bus 30. In other words, the independent heating flexible circuit board may not be provided, rather the heating pins connected to the positive heating bus 20 and the negative heating bus 30 and display pins for providing signals for display are combined in one flexible circuit board (a driving integrated circuit IC is bonded and connected to the flexible circuit board), which is beneficial for reducing the bezel space.

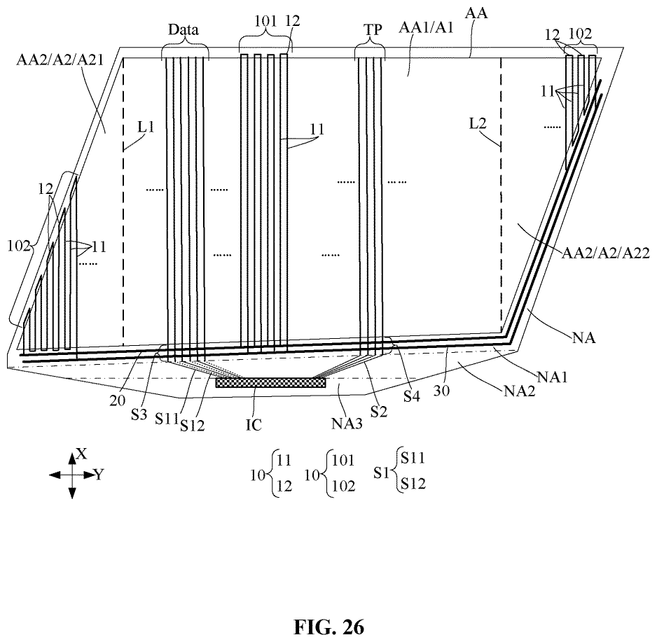

In the case that the heating line 10 in the display area AA is first connected to the positive heating bus 20 and the negative heating bus 30 in the non-display area NA, and then connected to the heating pin through the positive heating bus 20 and the negative heating bus 30, in some embodiments of the present disclosure, as shown in FIG. 26, which shows a schematic structural diagram of another display panel according to the present disclosure, it can be seen that the non-display area NA of the display panel includes a first region NA1, a second region NA2, and a third region NA3 that are located on a side of the display area AA and arranged in a direction away from the display area AA, and the third region NA3 is bonded and connected with the driving integrated circuit IC.

As shown in FIG. 26, the first region NA1 includes the positive heating bus 20 and the negative heating bus 30, one end of the heating line 10 is electrically connected to the positive heating bus 20, and another end of the heating line 10 is electrically connected to the negative heating bus 30; further, the positive heating bus 20 and the negative heating bus 30 may be electrically connected to heating pins in the driving integrated circuit IC, or may be electrically connected to heating pins of a separate heating flexible circuit board, thereby applying a voltage signal to the heating line 10 through the positive heating bus 20 and the negative heating bus 30.

With reference to FIG. 26 and FIG. 17 to FIG. 25, the display area AA includes multiple data lines Data and multiple touch control lines TP, and the second region NA2 (i.e., the fan-out region) includes multiple data fan-out lines S1 and multiple touch control fan-out lines S2. The data line Data is electrically connected to the driving integrated circuit IC (in one embodiment, may be connected to data pins) through the data fan-out line S1, and the touch control line TP is electrically connected to the driving integrated circuit IC (in one embodiment, may be connected to touch control pins) through the touch control fan-out line S2. Thus, the driving integrated circuit IC can provide a data signal to the data line Data in the display area AA through the data fan-out line S1, and provide a touch control signal to the touch control line TP in the display area AA through the touch control fan-out line S2.

Moreover, considering that the closer the data fan-out lines S1 are to the driving integrated circuit IC, the denser they are arranged in the second region NA2 (i.e., the fan-out region), therefore, with reference to FIG. 26 and FIG. 17 to FIG. 25, it can be set that the data fan-out lines S1 include a first data fan-out line S11 and a second data fan-out line S12, the first data fan-out line S11 and the second data fan-out line S12 are electrically connected to different data lines Data, the first data fan-out line S11 and the second data fan-out line S12 are alternately arranged, and the first data fan-out line S11 and the second data fan-out line S12 are arranged in different layers. That is, the data lines Data in the display area AA are electrically connected to the data fan-out lines S1, and the data fan-out lines S1 are alternately arranged in the second region NA2 (i.e., the fan-out region) in the manner of ABAB, where A and B represent different metal layers. In this way, the arrangement density of the data fan-out lines in the same metal layer in the second region NA2 (i.e., the fan-out region) can be reduced, which is beneficial for narrowing the lower bezel of the display panel.

Further, in some embodiments of the present disclosure, as shown in FIG. 26, the first region of the non-display area NA further includes a data connection line S3, the data line Data in the display area AA is electrically connected to the first data fan-out line S11 or the second data fan-out line S12 through the data connection line S3, and the first data fan-out line S11 and the second data fan-out line S12 are then electrically connected to the driving integrated circuit IC; and, the first region of the non-display area NA further includes a touch control connection line S4, the touch control line TP in the display area AA is electrically connected to the touch control fan-out line S2 through the touch control connection line S4, and the touch control fan-out line S2 is then electrically connected to the driving integrated circuit IC.

In one embodiment, taking the display panel including a first metal layer M1, a second metal layer M2, and a third metal layer M3 stacked on a side of the substrate as an example, and with reference to FIG. 20 to FIG. 25, the heating line 10 in the display area AA may be located in the third metal layer M3, the data line Data may be located in the second metal layer M2, and the touch control line TP may be located in the second metal layer M2 or the third metal layer M3. In this case, the positive heating bus 20 located at the lower bezel of the display panel may be located in the first metal layer M1, and the negative heating bus 30 may be located in the third metal layer M3. Then, after being pulled down, the heating line 10 located in the third metal layer M3 in the display area AA is conducted with the positive heating bus 20 located in the first metal layer M1 through a via between the third metal layer M3 and the first metal layer M1; in addition, after being pulled down, the heating line 10 located in the third metal layer M3 in the display area AA is directly connected to the negative heating bus 30 on the same layer.

Moreover, the data connection line S3 located in the first region NA1 may be located in the second metal layer M2, and the first data fan-out line S11 and the second data fan-out line S12 located in the second region NA2 (i.e., the fan-out region) are alternately arranged in the manner of M1/M2/M1/M2, that is, the first data fan-out line S11 is located in one of the first metal layer M1 and the second metal layer M2, the second data fan-out line S12 is located in the other of the first metal layer M1 and the second metal layer M2, and the first data fan-out line S11 and the second data fan-out line S12 are alternately arranged. Then, the data line Data located in the second metal layer M2 in the display area AA is first led out through the data connection line S3 located in the second metal layer M2 in the first region NA1, and then electrically connected to the driving integrated circuit IC through the first data fan-out line S11 or the second data fan-out line S12 in the second region NA2 (i.e., the fan-out region).

Furthermore, the touch control connection line S4 located in the first region NA1 may be located in the second metal layer M2, and the touch control fan-out line S2 located in the second region NA2 (i.e., the fan-out region) may be located in the third metal layer M3. Then, the touch control line TP located in the second metal layer M2 or the third metal layer M3 in the display area AA is electrically connected to the driving integrated circuit IC sequentially through the touch control connection line S4 (located in the second metal layer M2) in the first region NA1 and the touch control fan-out line S2 (located in the third metal layer M3) in the second region NA2 (i.e., the fan-out region).

In the first region NA1, since the heating line 10 located in the third metal layer M3 in the display area AA is conducted with the positive heating bus 20 located in the first metal layer M1 through a via between the third metal layer M3 and the first metal layer M1 after being pulled down, and in addition, the heating line 10 located in the third metal layer M3 in the display area AA is directly connected to the negative heating bus 30 on the same layer after being pulled down, i.e., the heating lines occupy the first metal layer M1 and the third metal layer M3 in total, in the first region NA1, the data connection line S3 and the touch control connection line S4 may both be located in the second metal layer M2.

It can also be understood that, in the second region NA2 (i.e., the fan-out region), since the first data fan-out lines S11 and the second data fan-out lines S12 are alternately arranged in the manner of M1/M2/M1/M2, the touch control fan-out line S2 in the second region NA2 (i.e., the fan-out region) is further switched to the third metal layer M3.

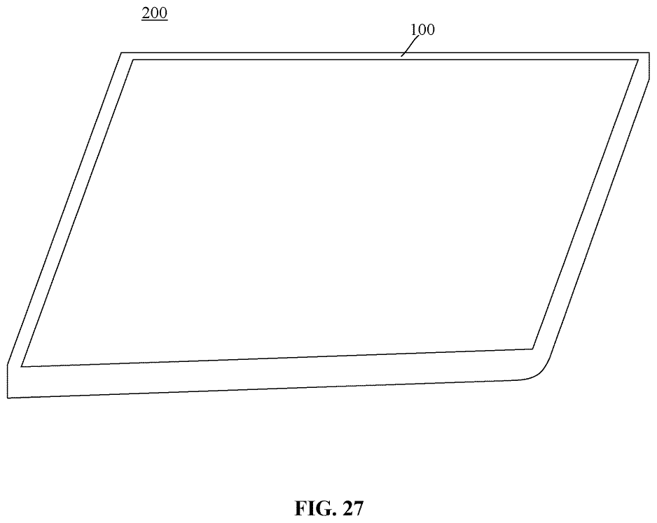

Accordingly, the present disclosure further provides a display device. As shown in FIG. 27, the display device 200 includes a display panel 100, and the display panel 100 may be the display panel according to any of the above embodiments. Since the display panel 100 has been described in detail in the foregoing embodiments, reference can be made to the foregoing embodiments, and details are not repeated here.

The display device 200 may be any electronic device with a display function, such as an electronic rearview mirror, a mobile phone, a tablet computer, a notebook computer, an electronic paper book, or a television.

The display device 200 may also be a display screen loaded on various vehicles, for example, a vehicle-mounted display screen.

It can be known from the above embodiments that the display panel and the display device according to the present disclosure achieve at least the following beneficial effects.

The display panel according to the present disclosure includes a display area and a non-display area at least partially surrounding the display area, the display area being non-rectangular; the display panel further includes multiple heating lines, at least part of the heating line is located in the display area, two ends of the heating line are located in the non-display area, each of the heating lines includes at least two first sub-segments, the first sub-segments extend along a first direction and are arranged along a second direction, and the first direction and the second direction intersect; the first sub-segments in one heating line are connected in series through a second sub-segment; the multiple heating lines include a first heating line and a second heating line, the number of first sub-segments in the second heating line is different from the number of first sub-segments in the first heating line, and/or, an arrangement density of the first sub-segments along the second direction in the second heating line is different from an arrangement density of the first sub-segments along the second direction in the first heating line; a difference between a length of the first heating line and a length of the second heating line is not greater than a first threshold. In the present disclosure, by setting in the display area the number of first sub-segments in the second heating line to be different from the number of first sub-segments in the first heating line, and/or, the arrangement density of the first sub-segments along the second direction in the second heating line to be different from the arrangement density of the first sub-segments along the second direction in the first heating line, the difference between the lengths of the two heating lines is made not greater than the first threshold, i.e., the lengths of the two heating lines are approximately equal to each other, and the resistances of the two heating lines are approximately equal to each other, and thus the heating powers of the two heating lines are approximately equal to each other, thereby improving the uniformity of heating temperatures in different regions of the display area, and improving the display effect of the display panel under low-temperature conditions.

Various parts in this specification are described in a combined manner of parallelism and progression, each part focuses on the differences from other parts, and the same and similar parts among various parts can be mutually referred to.

The above description of the disclosed embodiments enables one to implement or use the present application, and the features described in the various embodiments in this specification can be mutually replaced or combined. Various modifications to these embodiments will be apparent, and the general principles defined herein can be implemented in other embodiments without departing from the spirit or scope of the present application. Therefore, the present application will not be limited to the embodiments shown herein, but shall conform to the widest scope consistent with the principles and novel features disclosed herein.

1. A display panel, comprising:
a display area and a non-display area at least partially surrounding the display area, the display area being non-rectangular; and
a plurality of heating lines, at least a part of the heating line being located in the display area, and both ends of the heating line being located in the non-display area;
wherein each of the plurality of heating lines comprises at least two first sub-segments, the first sub-segments extending along a first direction and being arranged along a second direction, the first direction and the second direction intersecting each other, the first sub-segments in a same one of the plurality of heating lines being connected in series through a second sub-segment;
the plurality of heating lines comprise a first heating line and a second heating line, wherein the number of first sub-segments in the second heating line is different from the number of first sub-segments in the first heating line, and/or an arrangement density of the first sub-segments in the second heating line along the second direction is different from an arrangement density of the first sub-segments in the first heating line along the second direction; and
a difference between a length of the first heating line and a length of the second heating line is not greater than a first threshold.

2. The display panel according to claim 1, wherein a difference between an area of the display area corresponding to a region enclosed by the first heating line and an area of the display area corresponding to a region enclosed by the second heating line is not greater than a second threshold.

3. The display panel according to claim 1, wherein the display area comprises a first edge and a second edge arranged opposite to each other along the first direction, the first edge and the second edge being non-parallel to each other;
both ends of the first heating line and both ends of the second heating line are located on one side of the first edge of the display area;
both ends of the first sub-segment in the first heating line extend towards the first edge and the second edge respectively and both ends of the first sub-segment in the second heating line extend towards the first edge and the second edge respectively; and
the number of the first sub-segments in the second heating line is equal to the number of the first sub-segments in the first heating line, an average length of the first sub-segments in the second heating line is less than an average length of the first sub-segments in the first heating line, and the arrangement density of the first sub-segments in the second heating line along the second direction is less than the arrangement density of the first sub-segments in the first heating line along the second direction.

4. The display panel according to claim 1, wherein the display area comprises a first display sub-area and a second display sub-area, at least a part of the first heating line is located in the first display sub-area, the first heating line comprises m first sub-segments, at least a part of the second heating line is located in the second display sub-area, the second heating line comprises n first sub-segments, n>m, m≥2, n≥4, and both m and n are even numbers.

5. The display panel according to claim 4,
wherein the arrangement density of the first sub-segments in the second heating line along the second direction is different from the arrangement density of the first sub-segments in the first heating line along the second direction.

6. The display panel according to claim 4,
wherein the display area comprises a first edge and a second edge arranged opposite to each other along the first direction, and a third edge connecting the first edge and the second edge, an included angle between the third edge and the first edge being an acute angle, and an included angle between the third edge and the second edge being an obtuse angle;
the first edge is divided into a first sub-edge and a second sub-edge by a first virtual line, the first virtual line extending along the first direction;
the first display sub-area comprises the first sub-edge, the second edge, and the first virtual line, the second display sub-area comprises at least one first-type second display sub-area, the first-type second display sub-area comprising the second sub-edge, the third edge, and the first virtual line;
both ends of the first heating line and both ends of the second heating line in the first-type second display sub-area are located on one side of the first edge of the display area; and
both ends of the first sub-segment in the first heating line extend towards the first sub-edge and the second edge respectively, and both ends of the first sub-segment of the second heating line in the first-type second display sub-area extend towards the second sub-edge and the third edge respectively;
or,
wherein the display area comprises a first edge and a second edge arranged opposite to each other along the first direction, and a fourth edge connecting the first edge and the second edge, an included angle between the fourth edge and the first edge being an obtuse angle, and an included angle between the fourth edge and the second edge being an acute angle;
the second edge is divided into a third sub-edge and a fourth sub-edge by a second virtual line, the second virtual line extending along the first direction;
the first display sub-area comprises the first edge, the third sub-edge, and the second virtual line; the second display sub-area comprises at least one second-type second display sub-area, the second-type second display sub-area comprising the fourth sub-edge, the fourth edge, and the second virtual line;
both ends of the first heating line are located on one side of the first edge of the display area, and both ends of the second heating line in the second-type second display sub-area are located on one side of the fourth edge of the display area; and
both ends of the first sub-segment in the first heating line extend towards the first edge and the third sub-edge respectively, and both ends of the first sub-segment of the second heating line in the second-type second display sub-area extend towards the fourth edge and the fourth sub-edge respectively; or,
wherein the display area comprises a first edge and a second edge arranged opposite to each other along the first direction, and a third edge and a fourth edge connecting the first edge and the second edge;
an included angle between the third edge and the first edge is an acute angle, and an included angle between the third edge and the second edge is an obtuse angle;
an included angle between the fourth edge and the first edge is an obtuse angle, and an included angle between the fourth edge and the second edge is an acute angle;
the first edge is divided into a first sub-edge and a second sub-edge by a first virtual line, the first virtual line extending along the first direction;
the second edge is divided into a third sub-edge and a fourth sub-edge by a second virtual line, the second virtual line extending along the first direction;
the first display sub-area comprises the first sub-edge, the third sub-edge, the first virtual line, and the second virtual line;
the second display sub-area comprises a first-type second display sub-area and a second-type second display sub-area, the first-type second display sub-area comprising the second sub-edge, the third edge, and the first virtual line, and the second-type second display sub-area comprising the fourth sub-edge, the fourth edge, and the second virtual line;
both ends of the first heating line and both ends of the second heating line in the first-type second display sub-area are located on one side of the first edge of the display area, and both ends of the second heating line in the second-type second display sub-area are located on one side of the fourth edge of the display area; and
both ends of the first sub-segment in the first heating line extend towards the first sub-edge and the third sub-edge respectively, both ends of the first sub-segment of the second heating line in the first-type second display sub-area extend towards the second sub-edge and the third edge respectively, and both ends of the first sub-segment of the second heating line in the second-type second display sub-area extend towards the fourth edge and the fourth sub-edge respectively.

7. The display panel according to claim 6, wherein in a direction towards the first display sub-area, lengths of the first sub-segments in the second heating line gradually increase; or,
wherein in a direction towards the first display sub-area, the numbers of the first sub-segments in second heating lines in the second display sub-area gradually decrease;
or,
wherein the first edge and the second edge are arranged in parallel with each other; and
in the first display sub-area, the first sub-segments are uniformly arranged along the second direction; or,
wherein the first edge and the second edge are non-parallel to each other;
in the first display sub-area, the number of the first sub-segments in each first heating line is the same; and
the first heating line comprises a first-type first heating line and a second-type first heating line, an average length of first sub-segments in the second-type first heating line is less than an average length of first sub-segments in the first-type first heating line, and the arrangement density of the first sub-segments in the second-type first heating line along the second direction is less than the arrangement density of the first sub-segments in the first-type first heating line along the second direction.

8. The display panel according to claim 6, wherein the display panel comprises a positive heating bus and a negative heating bus located in the non-display area, one end of the heating line being electrically connected to the positive heating bus, and another end of the heating line being electrically connected to the negative heating bus; and
the positive heating bus and the negative heating bus are located on one side of the first edge of the display area and extend along the first edge; or,
wherein the display panel comprises a positive heating bus and a negative heating bus located in the non-display area, one end of the heating line being electrically connected to the positive heating bus, and another end of the heating line being electrically connected to the negative heating bus; and
the positive heating bus comprises a first part and a second part, the negative heating bus comprises a third part and a fourth part, the first part and the third part are located on one side of the first edge of the display area and extend along the first edge, and the second part and the fourth part are located on one side of the fourth edge of the display area and extend along the fourth edge.

9. The display panel according to claim 1, wherein the display panel comprises a plurality of sub-pixels arranged in an array along a row direction and a column direction;
the display panel comprises a plurality of gate lines and a plurality of data lines, the gate line extending along the row direction, and the data line extending along the column direction;
a row of sub-pixels is electrically connected to at least one of the plurality of gate lines, and at least one column of sub-pixels is electrically connected to one of the plurality of data lines; and
an extension direction of the first sub-segment in the heating line is the same as an extension direction of the gate line.

10. The display panel according to claim 9, wherein the display panel comprises a substrate, and a first metal layer and a second metal layer stacked on a side of the substrate;
the gate line is located in the first metal layer, and the data line is located in the second metal layer;
the heating line is located in the first metal layer, the first sub-segment of the heating line is located between at least a subset of adjacent ones of the plurality of gate lines, and in a direction perpendicular to a plane where the substrate is located, the first sub-segment of the heating line overlaps with the row of sub-pixels.

11. The display panel according to claim 9, wherein the display panel comprises a substrate, and a first metal layer, a second metal layer, and a third metal layer stacked on a side of the substrate;
the display panel further comprises a plurality of touch control lines, an extension direction of the touch control line being the same as an extension direction of the data line;
the gate line is located in the first metal layer, and the data line and the touch control line are respectively located in the second metal layer and the third metal layer;
the heating line is located in the first metal layer, the first sub-segment of the heating line is located between at least a subset of adjacent ones of the plurality of gate lines, and in a direction perpendicular to a plane where the substrate is located, the first sub-segment of the heating line overlaps with the row of sub-pixels.

12. The display panel according to claim 9, wherein the display panel comprises a substrate, and a first metal layer, a second metal layer, and a third metal layer stacked on a side of the substrate;
the display panel further comprises a plurality of touch control lines, an extension direction of the touch control line being the same as an extension direction of the data line;
the gate line is located in the first metal layer, the data line and the touch control line are both located in one of the second metal layer and the third metal layer, and the heating line is located in the other of the second metal layer and the third metal layer.

13. The display panel according to claim 1, wherein the display panel comprises a plurality of sub-pixels arranged in an array along a row direction and a column direction;
the display panel comprises a plurality of gate lines and a plurality of data lines, the gate line extending along the row direction, and the data line extending along the column direction;
a row of sub-pixels is electrically connected to at least one of the plurality of gate lines, and at least one column of the sub-pixels is electrically connected to one of the plurality of data lines; and
an extension direction of the first sub-segment in the heating line is the same as an extension direction of the data line.

14. The display panel according to claim 13, wherein the display panel comprises a substrate, and a first metal layer and a second metal layer stacked on a side of the substrate;
the gate line is located in the first metal layer, and the data line is located in the second metal layer; and
the heating line is located in the second metal layer and are insulated from the data line.

15. The display panel according to claim 14, wherein emission colors of each two adjacent sub-pixels in the row of sub-pixels are different from each other, and emission colors of sub-pixels in a column of the sub-pixels are the same;
the column of the sub-pixels is electrically connected to one of the plurality of data lines, and the data line electrically connected to the column of the sub-pixels is located on a side of the column of the sub-pixels along the row direction;
the display panel comprises a plurality of columns of pixel groups, the column of pixel groups comprising three columns of sub-pixels, and emission colors of the three columns of sub-pixels being different from each other; and
the first sub-segment of the heating line is located between at least a subset of adjacent ones of the plurality of columns of pixel groups;
or,
wherein emission colors of each two adjacent sub-pixels in the row of sub-pixels are different from each other, and emission colors of sub-pixels in a column of the sub-pixels are the same;
the row of sub-pixels is electrically connected to two of the plurality of gate lines, the two gate lines electrically connected to the row of sub-pixels are located on two sides of the row of sub-pixels along the column direction, and each two adjacent sub-pixels in the row of sub-pixels are electrically connected to different ones of the plurality of gate lines and are electrically connected to a same one of the plurality of data lines; and
an orthographic projection of the first sub-segment of the heating line on the plane where the substrate is located is located between orthographic projections of at least a subset of adjacent ones of the plurality of data lines on the plane where the substrate is located;
or,
wherein emission colors of sub-pixels in the row of sub-pixels are the same, and emission colors of each two adjacent sub-pixels in a column of the sub-pixels are different from each other;
the row of sub-pixels is electrically connected to one of the plurality of gate lines, and the column of the sub-pixels is electrically connected to one of the plurality of data lines; and
the first sub-segment of the heating line is located between at least a subset of adjacent ones of the plurality of data lines, and in the direction perpendicular to the plane where the substrate is located, the first sub-segment of the heating line overlaps with the column of the sub-pixels.

16. The display panel according to claim 13, wherein the display panel comprises a substrate, and a first metal layer, a second metal layer, and a third metal layer stacked on a side of the substrate;
the display panel further comprises a plurality of touch control lines, an extension direction of the touch control line being the same as an extension direction of the data line; and
the gate line is located in the first metal layer, the data line and the touch control line are respectively located in the second metal layer and the third metal layer, and the heating line is located in the second metal layer or the third metal layer.

17. The display panel according to claim 16, wherein emission colors of each two adjacent sub-pixels in the row of sub-pixels are different from each other, and emission colors of sub-pixels in a column of the sub-pixels are the same;
the column of the sub-pixels is electrically connected to one of the plurality of data lines, and the data line electrically connected to the column of the sub-pixels is located on a side of the column of the sub-pixels along the row direction;
the display panel comprises a plurality of columns of pixel groups, the column of pixel groups comprising three columns of sub-pixels, and emission colors of the three columns of sub-pixels being different from each other; and
in the direction perpendicular to the plane where the substrate is located, the touch control line at least partially overlaps with the data line, and the first sub-segment of the heating line is located between at least a subset of adjacent ones of the plurality of columns of pixel groups;
or, in the direction perpendicular to the plane where the substrate is located, the first sub-segment of the heating line overlaps with at least a subset of the plurality of data lines, and the touch control line is located between two adjacent ones of the plurality of columns of pixel groups.

18. The display panel according to claim 16, wherein emission colors of each two adjacent sub-pixels in the row of sub-pixels are different from each other, and emission colors of sub-pixels in a column of the sub-pixels are the same;
the row of sub-pixels is electrically connected to two of the plurality of gate lines, the two gate lines electrically connected to the row of sub-pixels are located on two sides of the row of sub-pixels, and each two adjacent sub-pixels in the row of sub-pixels are electrically connected to different ones of the plurality of gate lines and are electrically connected to a same one of the plurality of data lines; and
in the direction perpendicular to the plane where the substrate is located, the touch control line at least partially overlaps with the data line, and the first sub-segment of the heating line is located between at least a subset of adjacent ones of the plurality of data lines;
or, in the direction perpendicular to the plane where the substrate is located, the first sub-segment of the heating line overlaps with at least a subset of the plurality of data lines, and the touch control line is located between two adjacent ones of the plurality of data lines;
or
wherein emission colors of sub-pixels in the row of sub-pixels are the same, and emission colors of each two adjacent sub-pixels in a column of the sub-pixels are different from each other;
the row of sub-pixels is electrically connected to one of the plurality of gate lines, and the column of the sub-pixels is electrically connected to one of the plurality of data lines; and
the first sub-segment of the heating line is located between at least a subset of adjacent ones of the plurality of data lines, and in the direction perpendicular to the plane where the substrate is located, the first sub-segment of the heating line overlaps with the column of the sub-pixels, and the touch control line at least partially overlaps with the data line;
or, the touch control line is located between two adjacent ones of the plurality of data lines, and in the direction perpendicular to the plane where the substrate is located, the touch control line overlaps with the column of the sub-pixels, and the first sub-segment of the heating line overlaps with at least a subset of the plurality of data lines.

19. The display panel according to claim 1, wherein the non-display area comprises a first region, a second region, and a third region arranged on a side of the display area in a direction away from the display area, a driving integrated circuit being bonded and connected to the third region;
the first region comprises a positive heating bus and a negative heating bus, one end of the heating line being electrically connected to the positive heating bus, and another end of the heating line being electrically connected to the negative heating bus;
the display area comprises a plurality of data lines and a plurality of touch control lines, the second region comprises a plurality of data fan-out lines and a plurality of touch control fan-out lines, the data line being electrically connected to the driving integrated circuit through the data fan-out line, and the touch control line being electrically connected to the driving integrated circuit through the touch control fan-out line; and
the data fan-out lines comprise a first data fan-out line and a second data fan-out line, the first data fan-out line and the second data fan-out line being electrically connected to different ones of the plurality of data lines, the first data fan-out line and the second data fan-out line being alternately arranged, and the first data fan-out line and the second data fan-out line being arranged in different layers.

20. A display device, comprising a display panel, the display panel comprising:
a display area and a non-display area at least partially surrounding the display area, the display area being non-rectangular; and
a plurality of heating lines, at least a part of the heating line being located in the display area, and both ends of the heating line being located in the non-display area;
wherein each of the plurality of heating lines comprises at least two first sub-segments, the first sub-segments extending along a first direction and being arranged along a second direction, the first direction and the second direction intersecting each other, the first sub-segments in a same one of the plurality of heating lines being connected in series through a second sub-segment;
the plurality of heating lines comprise a first heating line and a second heating line, wherein the number of first sub-segments in the second heating line is different from the number of first sub-segments in the first heating line, and/or an arrangement density of the first sub-segments in the second heating line along the second direction is different from an arrangement density of the first sub-segments in the first heating line along the second direction; and
a difference between a length of the first heating line and a length of the second heating line is not greater than a first threshold.
